(19) United States
(12) Patent Application Publication
(10) Pub. No.: US 2008/0311299 A1
(43) Pub. Date: Dec. 18, 2008

(54) INK-JET RECORDING METHOD AND INK-JET RECORDING DEVICE

(75) Inventor: Koji FURUKAWA, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/862,748

(22) Filed: Sep. 27, 2007

(30) Foreign Application Priority Data
Sep. 27, 2006 (JP) 2006-262406
Jun. 20, 2007 (JP) 2007-162884

(51) Int. Cl. B05D 5/04; B05C 11/00

(52) U.S. Cl. 427/261; 118/46

(57) ABSTRACT

The ink-jet recording method and device record an image by ejecting onto a recording medium an ink which cures upon exposure to active energy rays. The method and device apply an undercoat liquid to the recording medium so as to form thereon an undercoat layer of the undercoat liquid having a surface state, improve the surface state of the applied undercoat layer, semi-cure the undercoat liquid of the undercoat layer having the improved surface state, and form the image by ejecting the ink onto a semi-cured surface of the undercoat liquid of the undercoat layer. The method and device further curing completely the undercoat liquid of the undercoat layer and the ink of the image after forming the image.

The entire contents of all documents cited in this specification are incorporated herein by reference.

### BACKGROUND OF THE INVENTION

The present invention relates to an ink-jet recording method and an ink-jet recording device. More particularly, the invention relates to an ink-jet recording method and an ink-jet recording device well-suited for forming high-quality images at high speed.

Ink-jet recording systems which eject droplets of ink from ink nozzles are used in many printers for a number of reasons, such as the small size and low cost of the device and the ability to form an image on the recording medium without contact therewith. Of these ink-jet recording systems, piezoelectric ink-jet systems which use changes in the shape of piezoelectric elements to eject the ink and thermal ink-jet systems which use an ink bubbling effect induced by thermal energy to eject ink droplets excel in their high resolution and high-speed printability.

Recently, a key challenge in the field has been how to increase speed and resolution when printing is carried out by depositing droplets of ink onto plain paper or a non-water absorbing recording medium such as plastic.

That is, when recording is carried out on a recording medium that does not absorb water, if the drying and the penetration of droplets into the recording medium following deposition takes time, practical problems ensue, such as a tendency for the image to bleed and for mixing to occur between neighboring droplets of ink on the recording medium, impeding the formation of a sharp image.

When such mixing between droplets occurs, neighboring droplets that have been deposited on the medium coalesce, resulting in movement of the droplets. Hence, the droplets shift from the positions where they have landed, causing undesirable effects such as an uneven line width when creating fine lines and color unevenness when creating a colored surface. Moreover, because the extent of such line width unevenness and color unevenness on a colored surface differs according to the ink absorptivity and wettability at the surface of the recording medium, even assuming the ink used and the ink ejecting conditions to be uniform, the image that is formed will differ between various recording media.

Known methods for promoting the fixing of the ink droplets may be used to suppress undesirable effects such as image bleed and non-uniform line width. For example, JP-63-60783 A describes a method which, in order to provide high-resolution drawing property, involves using a reactive two-component ink in such a way as to have the two components react on the recording medium. In one embodiment, a basic polymer-containing liquid is deposited on the medium, after which recording is carried out with an anionic dye-containing ink. JP 8-174997 A describes a method that involves applying a cationic substance-containing liquid composition, then applying an ink which contains an anionic compound and a colorant.

JP 2004-42548 A discloses an ink jet recording method that employs an ultraviolet-curable ink. The dots of UV-curable ink ejected onto the recording medium are irradiated with ultraviolet light so as to match the ejection timing of the individual droplets, thereby thickening the ink and pre-curing the dots to a degree where neighboring dots do not intermix. The dots are then subjected to a primary curing step by additional exposure to ultraviolet light.

JP 2003-145745 A and JP 2004-42525 A propose techniques which ameliorate colored ink noticeability, bleeding, and image differences that arise between various recording media by uniformly applying to a transparent or semi-transparent non-absorptive recording medium a UV-curable white ink as an undercoat, irradiating ultraviolet light to solidify or thicken the white ink, then carrying out ink-jet recording using a radiation-curable color ink set. In addition, JP 2005-96254 A proposes a technique where, instead of the radiation-curable white ink, a substantially clear, active ray-curable ink is applied with an ink-jet head.

### SUMMARY OF THE INVENTION

However, although the method described in JP 2004-42548 A does indeed suppress bleeding, differences remain among the images obtained on various recording media, in addition to which problems such as the line width non-uniformity and color unevenness caused by mixture between droplets have not been fully resolved. Problems such as line width non-uniformity and color unevenness caused by mixture between droplets are also not fully resolved by the methods of JP 2003-145745 A and JP 2004-42525 A, and remain even in the method of JP 2005-96254 A.

It is therefore a first object of the present invention to provide an ink-jet recording method which effectively suppresses ink bleed regardless of the type of non-absorptive recording medium used, and is thus able to provide a high image uniformity among various recording media and suppress problems such as line width non-uniformity and color unevenness that arise from mixture between droplets, and which can prevent the deterioration in the surface state of the coated surface which sometimes arises in the step in which an undercoat liquid is provided on the recording medium, thus enabling even higher-quality images to be formed. A second object of the invention is to provide an ink-jet recording device for the same purpose.

In addressing these concerns, the inventor has discovered the technique described below. This technique is directed at an ink-jet recording method for recording an image by ejecting onto a recording medium an ink which cures upon exposure to active energy rays, the method being characterized by including the steps of applying an undercoat liquid to the recording medium, curing only the interior of the undercoat liquid, and forming an image by ejecting the ink onto the undercoat liquid which has been cured only at the interior. This technique is also directed at an ink-jet recording device for realizing the foregoing method.

Application of the undercoat liquid to the recording medium is generally carried out by a mechanical coating means of relatively simple construction such as a roll coater, or a spraying means with ink jets similar to those used for image formation. Regardless of which method of application is used, to achieve the above objects, it must be capable of forming a film of undercoat liquid having a surface state that is uniform and smooth over the entire surface of the recording medium.

However, undercoat liquids having a relative high viscosity of, e.g., about 50 to 500 mPa·s are often used. Moreover, especially when the undercoat liquid is exposed to active energy such as ultraviolet light after only a relatively short time interval following coating, the undercoat liquid may be subjected to semi-curing, such as inner curing (i.e., a state where the interior of the undercoat liquid is completely or partially cured, and the surface has a lower degree of cure than the interior and retains some fluidity). It is therefore critical to render the surface of the undercoat into a good state as described above.

In order to achieve the first object, a first aspect of the invention provides an ink-jet recording method for recording an image by ejecting onto a recording medium an ink which cures upon exposure to active energy rays, comprising: an applying step of an undercoat liquid for applying the undercoat liquid to the recording medium so as to form thereon an undercoat layer of the undercoat liquid having a surface state; an improving step of the surface state for improving the surface state of the applied undercoat layer; a semi-curing step of the undercoat liquid for semi-curing the undercoat liquid of the undercoat layer having the improved surface state; and an image-forming step for forming the image by ejecting the ink onto a semi-cured surface of the undercoat liquid of the undercoat layer.

The improving step is preferably carried out by blowing air over a coated surface of the undercoat liquid of the applied undercoat layer. The air blown over the coated surface of the applied undercoat layer preferably has a temperature of at least 25° C. but not more than 60° C.

Preferably, the image-forming step is carried out by forming a multicolor image comprised of inks of at least two colors, the image-forming step comprising: two or more single-color image-forming sub-steps, each single-color image-forming sub-step for forming a single-color image in one of the at least two colors by successively ejecting one of the inks of the at least two colors onto the recording medium; and one or more ink semi-curing sub-steps, each ink semi-curing sub-step for semi-curing the one of the inks which has been ejected onto the recording medium and is present uppermost thereon between the two single-color image-forming sub-steps for two respective colors. For example, it is preferable for the ink used to form the image to be an ink set of two or more colors, and for the image-forming step to include a sub-step of curing only the interior of the ink following each of the single-color image forming sub-steps.

The undercoat liquid is preferably a clear, white or achromatic liquid which includes a radical-polymerizable composition and is curable on exposure to the active energy rays.

Preferably, the ink-jet recording method of this aspect further comprises, following the image-forming step, a step of completely curing the undercoat liquid of the undercoat layer and the ink of the image.

In order to achieve the second object, a second aspect of the invention provides an ink-jet recording device comprising: applying means of an undercoat liquid for applying the undercoat liquid onto a recording medium so as to form thereon an undercoat layer of the undercoat liquid having a surface state; improving means of the surface state for improving the surface state of the applied undercoat layer, the improving means being disposed downstream from the applying means; semi-curing means of the undercoat liquid for semi-curing the applied undercoat liquid of the undercoat layer by exposure to active energy rays, the semi-curing means being disposed downstream from the improving means; image-forming means for forming an image by ejecting an ink which is curable on exposure to the active energy rays onto a semi-cured surface of the undercoat liquid of the undercoat layer, the image-forming means being disposed downstream from the semi-curing means; and complete curing means for completely curing by exposure to the active energy rays the undercoat liquid of the undercoat layer and the ink of the image, the complete curing means being disposed downstream from the image-forming means.

The improving means preferably comprises means for blowing air over a coated surface of the undercoat liquid of the applied undercoat layer. The air blown over the coated surface of the applied undercoat layer preferably has a temperature of at least 25° C. but not more than 60° C. In order words, the air blowing means preferably blows air having a temperature of at least 25° C. but not more than 60° C.

Preferably, the image-forming means has at least two ink-jet heads, each ink-jet head ejecting one of inks containing mutually differing colorants, the ink-jet recording device further comprising at least one ink semi-curing means for semi-curing one of the inks used to form the image with one of the at least two ink-jet heads which is disposed on an upstream side thereof in a direction of travel of the recording medium, the one of the at least one ink semi-curing means being disposed between two ink-jet heads. For example, it is preferable for the ink used to form the image to be an ink set of two or more colors, and for there to be an inner curing means which cures only the interior of the ink following the image forming step for each color.

The undercoat liquid is preferably a clear, white or achromatic liquid which includes a radical-polymerizable composition and is curable on exposure to the active energy rays.

The ink-jet recording method and ink-jet recording device of the invention effectively suppress ink bleed regardless of the type of non-absorptive recording medium used, and are thus able to provide a high image uniformity among differing recording media and suppress problems such as line width non-uniformity and color unevenness that arise from mixture between ink droplets. Moreover, they can prevent deterioration in the surface state of the coated surface which sometimes arises in the step in which an undercoat liquid is applied to the recording medium, thus enabling even higher-quality images to be formed.

### BRIEF DESCRIPTION OF THE INVENTION

In the accompanying drawings:

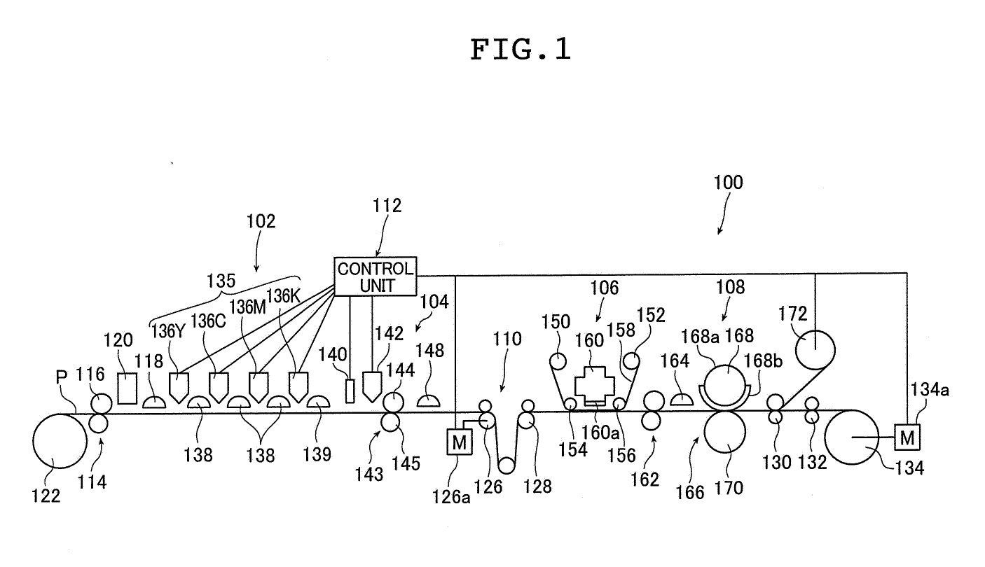

FIG. 1 is a front view showing, in simplified form, an embodiment of a digital label printer which employs an ink-jet recording device according to the invention;

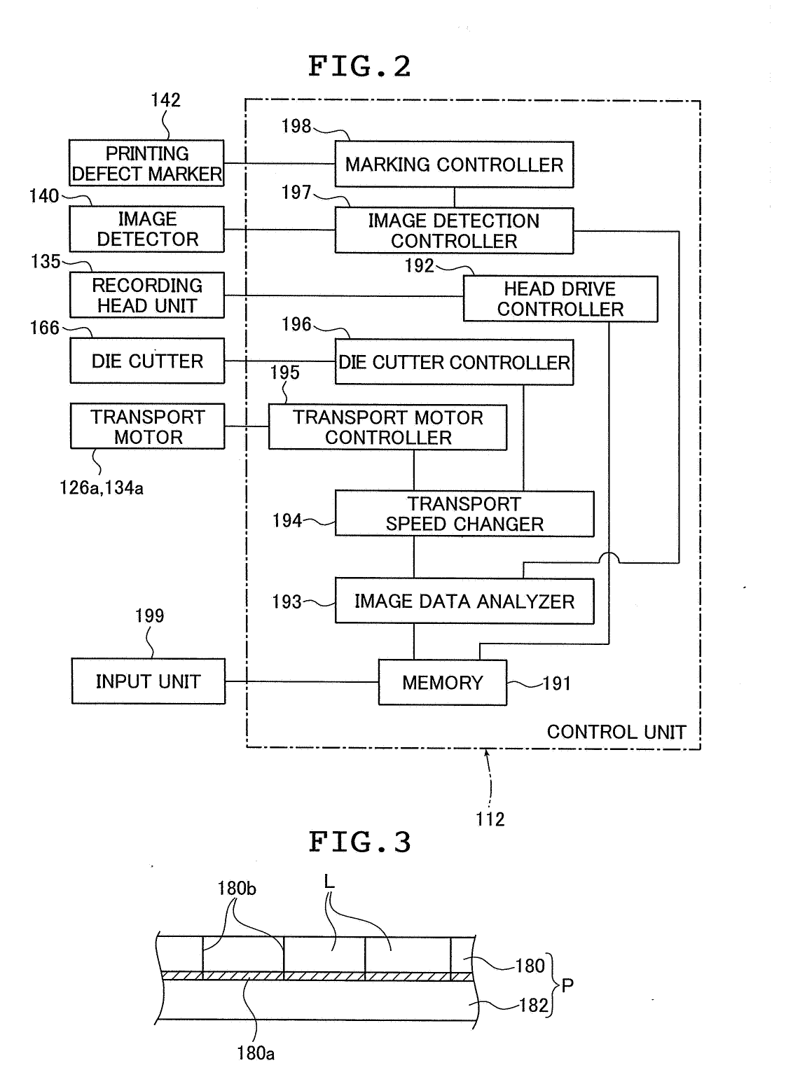

FIG. 2 is a block diagram illustrating a control unit for controlling the digital label printer shown in FIG. 1;

FIG. 3 is a longitudinal sectional view of a recording medium for printing labels such as may be used in the digital label printer shown in FIG. 1;

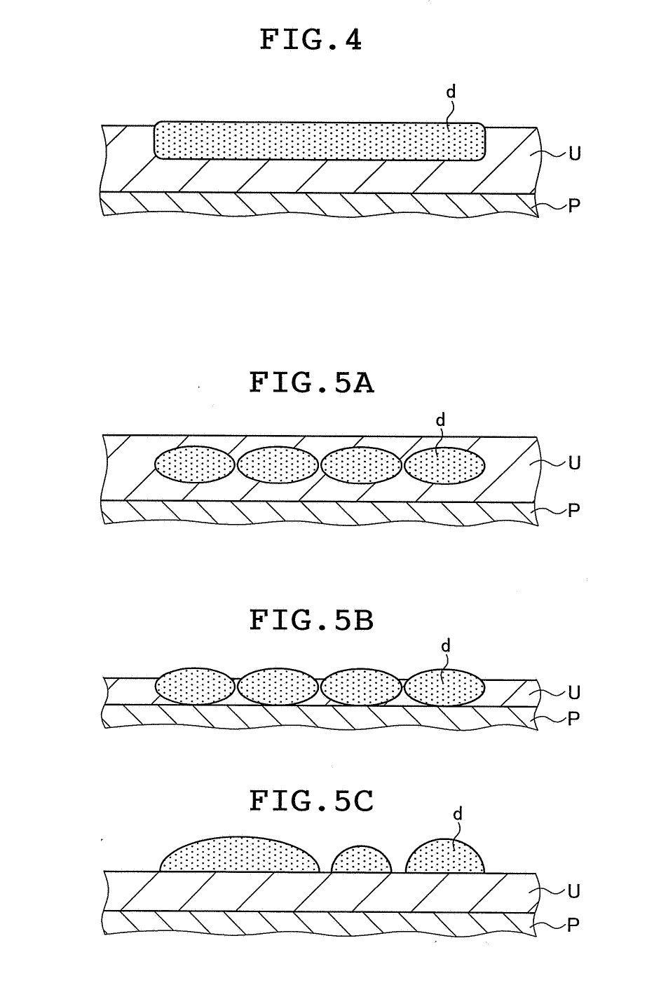

FIG. 4 is a schematic sectional view of a recording medium where ink droplets have been deposited onto a semi-cured undercoat liquid;

FIGS. 5A and 5B are schematic sectional views of recording media where ink droplets have been deposited onto an undercoat liquid that is in an uncured state, and FIG. 5C is a schematic sectional view of a recording medium where ink droplets have been deposited onto an undercoat liquid that is in a completely cured state;

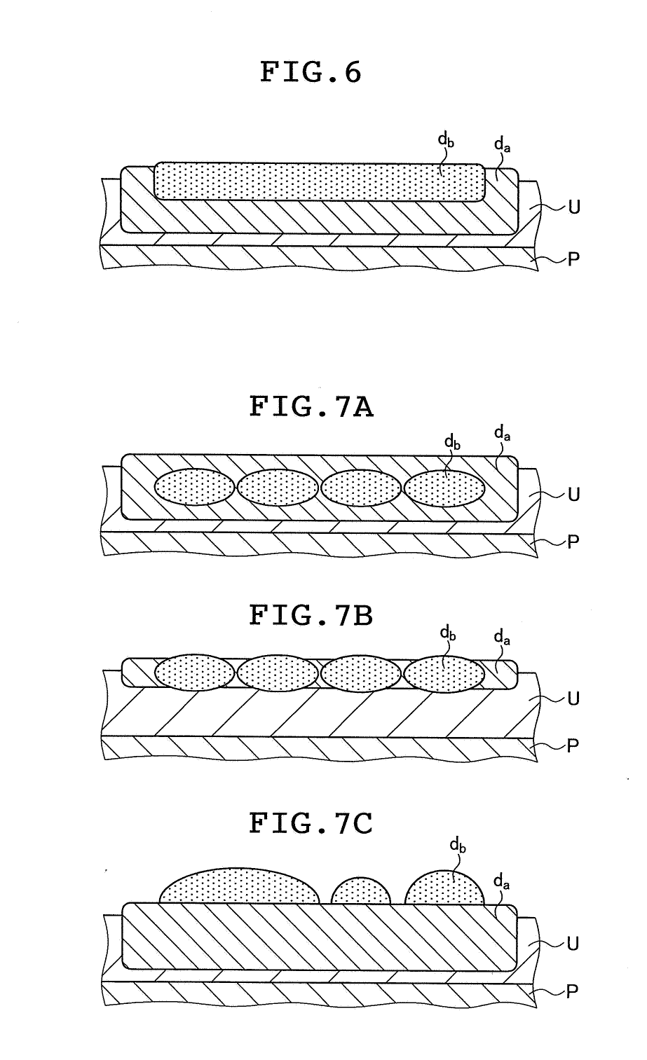

FIG. 6 is a schematic sectional view of a recording medium where ink droplets have been deposited onto a semi-cured liquid ink;

FIGS. 7A and 7B are schematic sectional views of recording media where ink droplets have been deposited onto liquid ink that is in an uncured state, and FIG. 7C is a schematic sectional view of a recording medium where ink droplets have been deposited onto ink that is in a completely cured state;

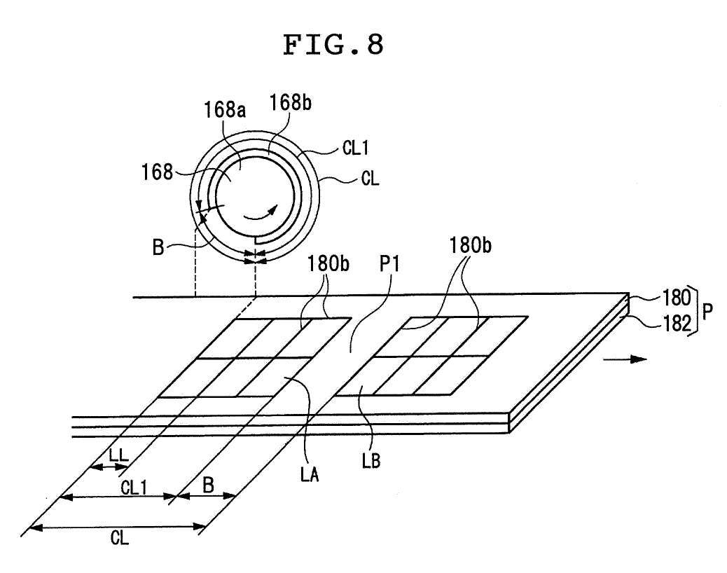

FIG. 8 is a cross-sectional view of a die cutter having slitting blades arranged on a cylindrical surface thereof, and a perspective view showing the condition of slits made in a pressure-sensitive adhesive sheet by continuously rotating the die cutter;

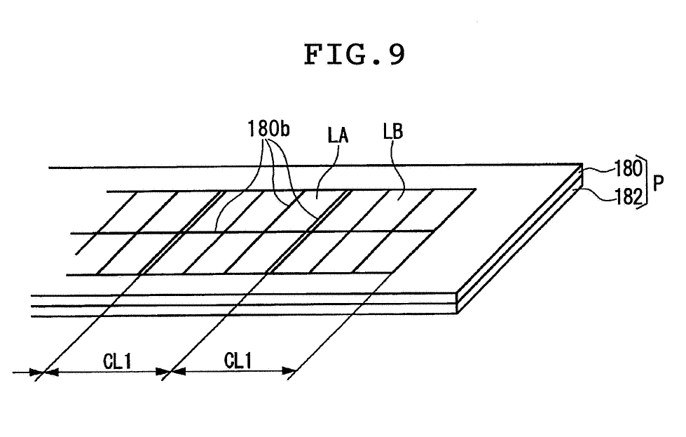

FIG. 9 is a perspective view showing the condition of slits made in a pressure-sensitive adhesive sheet with a die cutter;

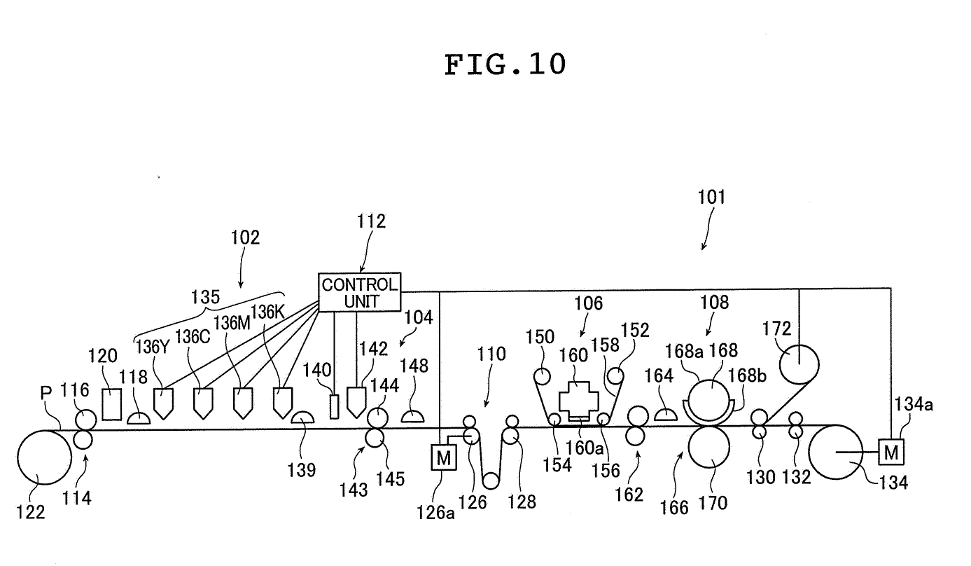

FIG. 10 is a front view showing, in simplified form, another embodiment of a digital label printer which employs an ink-jet recording device according to the invention;

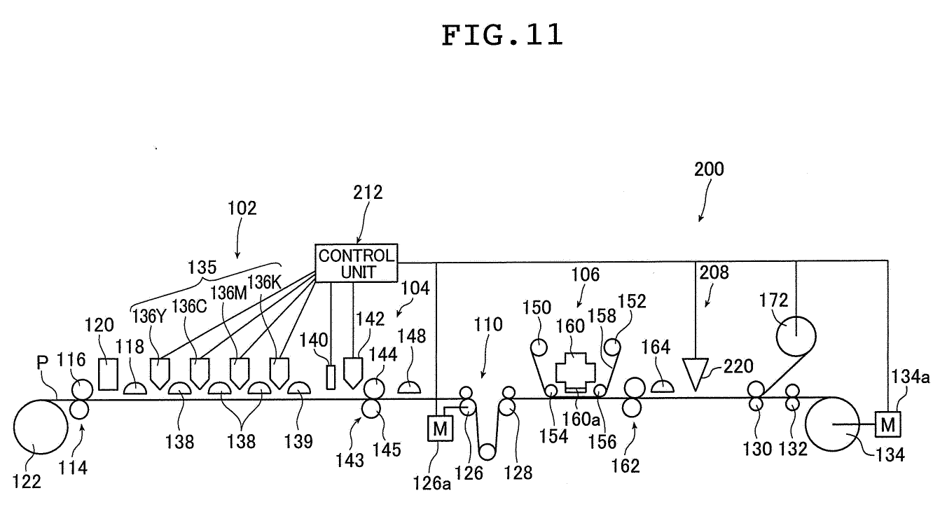

FIG. 11 is a front view showing, in simplified form, yet another embodiment of a digital label printer which uses the ink-jet recording device of the invention;

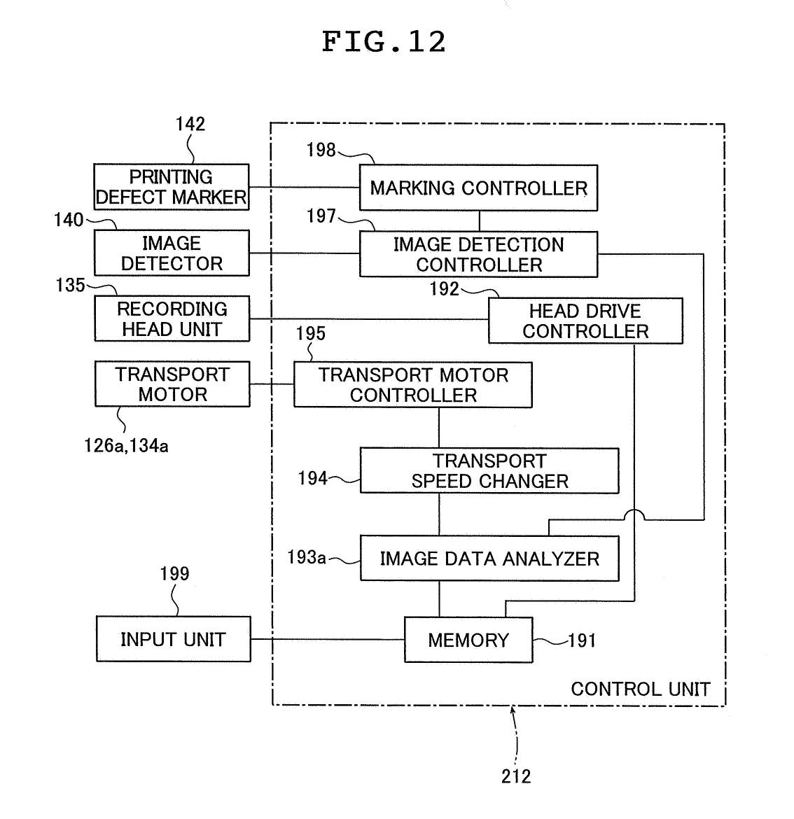

FIG. 12 is a block diagram illustrating a control unit for controlling the digital label printer shown in FIG. 11;

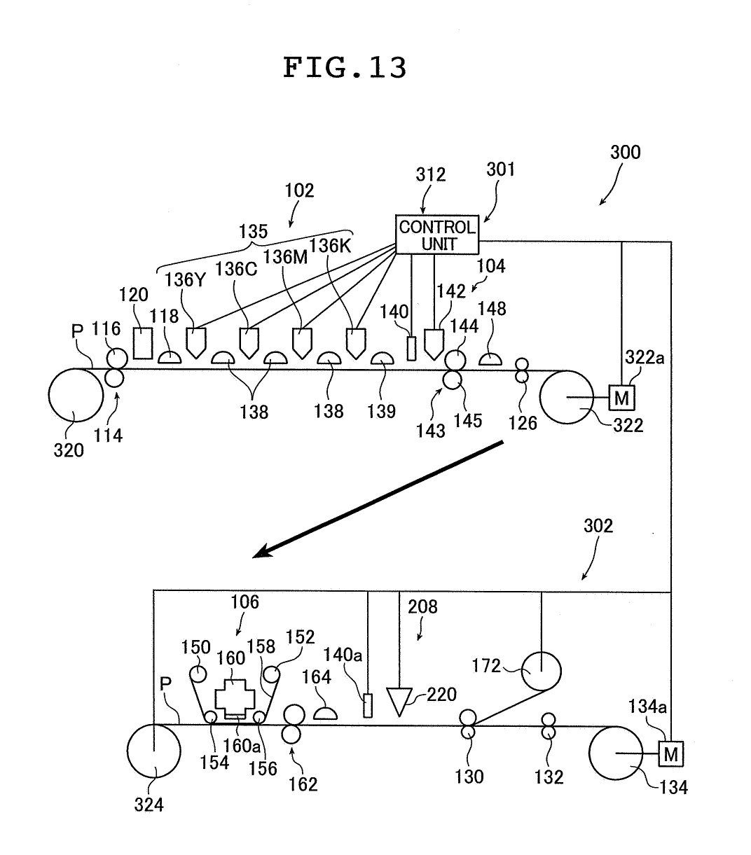

FIG. 13 is a front view showing, in simplified form, a still further embodiment of a digital label printer which uses the ink-jet recording device of the invention; and

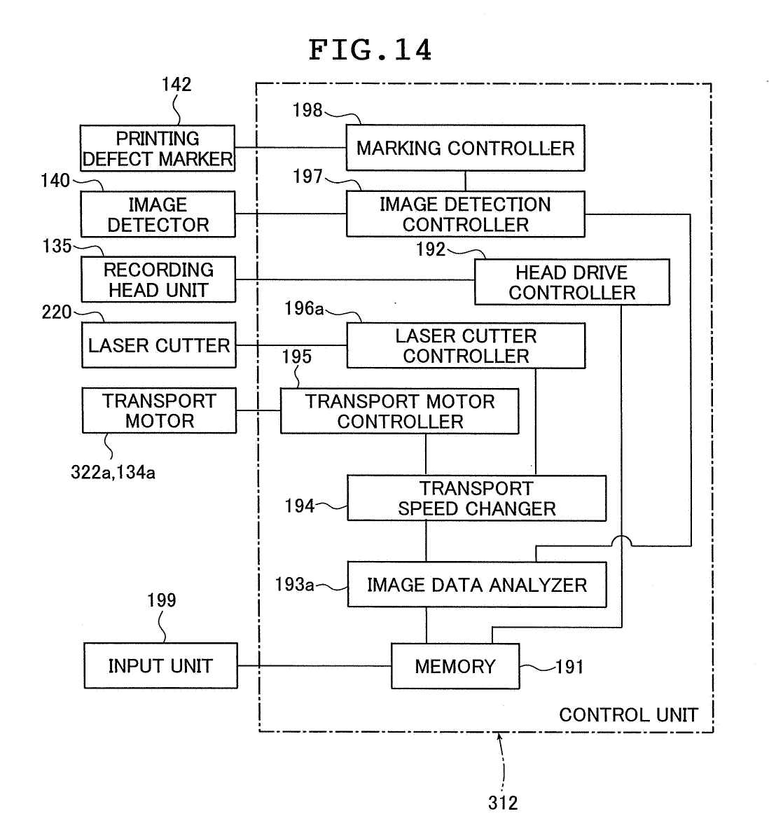

FIG. 14 is a block diagram illustrating a control unit for controlling the digital label printer shown in FIG. 13.

### DETAILED DESCRIPTION OF THE INVENTION

The invention is described more fully below based on the preferred embodiments shown in the accompanying drawings. In the following embodiments, digital label printers which use an ink-jet recording device are employed by way of illustration to describe the invention.

The digital label printers according to these embodiments carry out image formation by semi-curing an undercoat liquid which has been applied onto a recording medium, such as by curing only the interior of the undercoat liquid, then ejecting onto the undercoat which has been semi-cured, e.g., cured only at the interior, at least one ink that cures upon exposure to active energy rays.

FIG. 1 is a front view showing, in simplified form, a digital label printer which uses an ink-jet recording device according to one embodiment of the invention, FIG. 2 is a block diagram illustrating a control unit for controlling the digital label printer shown in FIG. 1, and FIG. 3 is a longitudinal sectional view of a recording medium for printing labels such as may be used in the digital label printer shown in FIG. 1.

A digital label printer 100 shown in the present embodiment prints an image onto a web-type recording medium P for printing labels (also referred to below as simply “the recording medium”) at an image-recording section (also called image-drawing section) 102, then makes label-shaped slits in the medium P with a die cutter in a post-treatment section 108. In addition, the printer 100 carries out, as a subsequent step, a waste removal operation in which unnecessary portions of the pressure-sensitive adhesive sheet are peeled from the backing sheet (peel sheet) and removed.

In each of the embodiments appearing below, an active energy curing-type digital label printer which uses a UV-curable ink as the active energy-curable ink that cures upon exposure to active energy is described by way of illustration. However, the invention is not limited in this regard, and may be applied to digital label recording devices which use any of various kinds of active energy-curable inks, as well as to any other type of digital label printer.

Referring to FIG. 3, the recording medium P used in the present embodiment has a two-layer construction composed of a peel sheet 182 as a backing sheet on which is laminated a pressure-sensitive adhesive sheet 180 coated on the back side thereof with a pressure-sensitive adhesive 180a.

As shown in FIG. 1, the digital label printer 100 has the image-recording section 102, a surface smoothing section 104, a foil stamping section 106, the post-treatment section 108, a transport section 110, and a control unit 112.

Here, the transport section 110 transports the recording medium P in a fixed direction (from left to right in FIG. 1). The image-recording section 102, the surface smoothing section 104, the foil stamping section 106 and the post-treatment section 108 are arranged in this order in the direction of travel of the recording medium P; that is, in the upstream to downstream direction. The control unit 112 is connected to the image-recording section 102, the surface smoothing section 104, the foil stamping section 106, the post-treatment section 108 and the transport section 110, and controls their respective operations.

The transport section 110 has a feed roll 122, transport roller pairs 126, 128, 130 and 132, a product roll 134, and transport motors 126a and 134a.

The feed roll 122 has the recording medium P wound thereon in the form of a roll.

The transport roller pairs 126, 128, 130 and 132 are arranged in this order from the upstream to the downstream side of the travel path of the recording medium P. These transport roller pairs 126, 128, 130 and 132 let out the recording medium P from the feed roll 122, and transport the recording medium P in a given direction (in the present embodiment, from left to right in FIG. 1).

The product roll 134, which is disposed the furthest downstream on the recording medium P travel path, i.e., in the direction of transport, takes up the recording medium P that has been transported over the travel path by the transport roller pairs 126, 128, 130 and 132 and has passed through the image-recording section 102, the surface smoothing section 104, the foil stamping section 106 and the post-treatment section 108.

The transport motors 126a and 134a are connected to, respectively, the transport roller pair 126 and the product roll 134, and rotatably drive the transport roller pair 126 and the product roll 134.

That is, in the present embodiment, the transport roller pair 126 and the product roll 134 connected to the transport motors 126a and 134a, respectively, are driven to rotate and thus serve as the drive rollers for transporting the recording medium P. The other transport roller pairs 128, 130 and 132 are driven rollers which rotate with movement of the recording medium P and regulate the recording medium P on the travel path.

In the transport section 110, the transport motors 126a and 134a rotatably drive the transport roller pair 126 and the product roll 134. Through this arrangement, the recording medium P is let out from the feed roll 122, passes through the image-recording section 102, the surface smoothing section 104, the foil stamping section 106 and the post-treatment section 108, and is taken up by the product roll 134.

In the present embodiment, a transport buffer is provided between the image-recording section 102 and the surface smoothing section 104 on the one side and the foil stamping section 106 and the post-treatment section 108 on the other side.

By providing such a transport buffer, it is possible to absorb slack that arises in a web-type recording medium P for printing labels due to a difference between the transport speed in the image-recording section 102 and the surface smoothing section 104, and the transport speed in the foil stamping section 106 and the post-treatment section 108, thus enabling the labels to be efficiently produced.

The transport motors 126a and 134a are connected to the subsequently described control unit 112 and their rotational speeds thereby controlled. This in turn controls the speed at which the web-type recording medium P for printing labels is transported by the transport section 110.

No particular limitation is imposed on the transport roller pairs which function as drive roller pairs. For example, transport motors may be provided for all the transport roller pairs, so that all the transport roller pairs function as drive roller pairs.

The image-recording section 102 has an undercoat-forming section 114, a recording head unit 135, UV irradiators 138 and 139, an image detector 140 and a printing defect marker 142.

The recording head unit 135 has recording heads (ink-jet heads) 136Y, 136C, 136M and 136K which are arrayed at positions facing the travel path of the recording medium P. That is, the ink nozzle tips are arranged so as to face the recording medium P.

As described above, the digital label printer 100 according to the present embodiment carries out image formation by semi-curing an undercoat liquid which has been applied onto the recording medium P (i.e., curing only the interior of the undercoat liquid), then ejecting onto an undercoat or an undercoat layer having a semi-cured undercoat liquid (cured only at the interior) at least one ink which semi-cures (cures only at the interior) upon exposure to active energy rays.

Here, the undercoat-forming section 114 has a roll coater 116 which applies an undercoat liquid onto the surface of the recording medium P to form an undercoat layer, a blower 120 which serves as a coated surface state-improving means for improving the surface state of the undercoat liquid after it has been applied to the recording medium P, and a UV irradiator 118 for semi-curing the applied undercoat liquid (i.e., for curing only the interior of the undercoat liquid).

This undercoat-forming section 114 applies an undercoat liquid to the recording medium P, improves the coated surface state on the side of the recording medium P where at least one undercoat liquid has been applied, and semi-cures the undercoat liquid (cures only the interior of the undercoat) in the undercoat layer. The digital label printer 100 then carries out image formation by ejecting at least one ink from the subsequent recording head unit 135 onto the undercoat liquid that has been semi-cured (cured only at the interior).

Semi-curing of the undercoat liquid in the undercoat layer is described more fully below.

As used herein, the term “semi-cured” signifies partial curing, and refers to the undercoat liquid in a partially cured, i.e., an incompletely cured, state. When the undercoat liquid that has been applied onto the recording medium (base material) P is semi-cured, the degree of curing may be non-uniform; preferably, the degree of curing proceeds in the depth direction of the undercoat liquid. In the present embodiment, the undercoat liquid which is semi-cured is an undercoat liquid which forms an undercoat. The undercoat liquid is typically a clear or white or achromatic liquid, and is preferably a liquid having an achromatic color such as low-density gray.

“Semi-curing,” and particularly “internal curing,” may also refer herein to a state where the interior of the undercoat liquid has completely or partially cured, but the surface of the undercoat liquid has a lower degree of cure than the interior and possesses a degree of fluidity. Whether such curing has occurred can be determined based on whether, when a permeable medium such as plain paper is pressed against the applied undercoat liquid following completion of the internal curing step (e.g., following exposure to active energy rays or heating) but prior to deposition of the ink droplets, the surface of the undercoat liquid transfers to the permeable medium.

For example, when a radical-polymerizable undercoat liquid is cured in air or air that is partially substituted with an inert gas, due to the radial polymerization-suppressing effect of oxygen, radical polymerization tends to be inhibited at the surface of the undercoat liquid. As a result, semi-curing is non-uniform, there being a tendency for curing to proceed at the interior of the undercoat liquid and to be delayed at the surface.

In the practice of the invention, by using a radical-photopolymerizable undercoat liquid in the presence of oxygen which tends to inhibit radical-polymerization, the undercoat liquid partially photocures, enabling the degree of cure of the undercoat liquid to be higher at the interior than at the exterior.

Alternatively, in cases where a cationic-polymerizable undercoat liquid is cured in air containing humidity, because moisture has a cationic polymerization-inhibiting effect, there is a tendency for curing to proceed at the interior of the undercoat liquid and to be delayed at the surface.

It is likewise possible for the degree of cure in the undercoat liquid to be made higher at the interior than at the exterior by using this cationic-polymerizable undercoat liquid under humid conditions that have a cationic polymerization-inhibiting effect so as to induce partial photocuring.

By thus semi-curing the undercoat liquid and depositing ink droplets on the semi-cured undercoat liquid, technical effects that are advantageous for the quality of the resulting print can be achieved. The mechanism of action can be confirmed by examining a cross-section of the print.

The semi-curing of the undercoat liquid (i.e., the undercoat formed of undercoat liquid on the recording medium) is described in detail below. As one illustration, high-density areas obtained by depositing about 12 pL of liquid ink (that is, droplets of ink) on the undercoat liquid in a semi-cured state having a thickness of about 5 μm that has been provided on a recording medium P are described below.

FIG. 4 is a schematic sectional view of a recording medium where ink droplets have been deposited onto a semi-cured undercoat liquid. FIGS. 5A and 5B are schematic sectional views of recording media where ink droplets have been deposited onto an undercoat liquid that is in an uncured state, and FIG. 5C is a schematic sectional view of a recording medium where ink droplets have been deposited onto an undercoat liquid that is in a completely cured state.

When the undercoat liquid is semi-cured according to the invention, the degree of cure on the recording medium P side is higher than the degree of cure at the surface layer. In this case, three features are observable. That is, as shown in FIG. 4, when ink d is deposited as droplets on a semi-cured undercoat liquid U, (1) a portion of the ink d emerges at the surface of the undercoat liquid U, (2) a portion of the ink d lies within the undercoat liquid U, and (3) the undercoat liquid is present between the bottom side of the ink d and the recording medium P.

When the ink d is deposited on the undercoat liquid U, if the undercoat liquid U and the ink d satisfy the above states (1), (2) and (3), the undercoat liquid U can be regarded as being in a semi-cured state.

By semi-curing the undercoat liquid U, that is, by curing the undercoat liquid U so that it satisfies above (1), (2) and (3), the droplets of ink d (i.e., the ink droplets) which have been deposited to a high density mutually connect, forming a film of the ink d (i.e., an ink film or ink layer), and thus providing a uniform and high color density.

By contrast, when the ink is deposited on the undercoat liquid which is in an uncured state, either or both of the following occurs: all of the ink d lies within the undercoat liquid U as shown in FIG. 5A; a state arises where, as shown in FIG. 5B, the undercoat liquid U is not present below the ink d.

In this case, even when the ink is applied to a high density, the liquid droplets are mutually independent, causing the color density to decrease.

When the ink is deposited on an undercoat liquid that is completely cured, as shown in FIG. 5C, a state will arise where the ink d does not lie within the undercoat liquid U.

In this case, interference in the deposition of the droplets arises, as a result of which a uniform ink film cannot be formed and a high color reproducibility cannot be achieved (i.e., this leads to a decrease in color reproducibility).

Here, when the droplets of ink are applied to a high density, the droplets are not independent of each other. To form a uniform ink film, and also to suppress the occurrence of deposition interference, the quantity of regions where the undercoat liquid (i.e., the undercoat) is uncured per unit surface area is preferably smaller, and more preferably substantially smaller, than the maximum quantity of droplets of ink applied per unit surface area. That is, the relationship between the weight Mᵤ (also referred to as M_{undercoat liquid}) of uncured regions of the undercoat per unit surface area and the maximum weight mᵢ (also referred to as mᵢₙₖ) of the ink ejected per unit surface area preferably satisfies the condition (mᵢ/30)<Mᵤ<mᵢ, more preferably satisfies the condition (mᵢ/20)<Mᵤ<(mᵢ/3), and most preferably satisfies the condition (mᵢ/10)<Mᵤ<(mᵢ/5). As used herein, the “maximum weight of ink ejected per unit surface area” refers to the maximum weight per color.

By letting (mᵢ/30)<Mᵤ, deposition interference can be prevented from occurring. Moreover, a high dot size reproducibility can be achieved. By letting Mᵤ<mᵢ, the ink film can be uniformly formed and a decrease in density can be prevented.

Here, the weight of uncured regions of the undercoat liquid per unit surface area is determined by a transfer test. Specifically, after completion of the semi-curing step (e.g., after exposure to active energy rays) and before deposition of the ink droplets, a permeable medium such as plain paper is pressed against the undercoat liquid which is in a semi-cured state, and the amount of the undercoat liquid that transfers to the permeable medium is determined by weight measurement. The measured value is defined as the weight of the uncured regions of the undercoat liquid.

For example, if the maximum amount of ink ejected is set to 12 picoliters per pixel at a deposition density of 600×600 dpi, the maximum weight mᵢ of the ink ejected per unit surface area becomes 0.74 mg/cm² (assuming the density of the ink is about 1.1 g/cm³). Therefore, in this case, the weight Mᵤ per unit surface area of uncured regions of the undercoat liquid is preferably greater than 0.025 mg/cm² but less than 0.74 mg/cm², more preferably greater than 0.037 mg/cm² but less than 0.25 mg/cm², and most preferably greater than 0.074 mg/cm² but less than 0.148 mg/cm².

Although no particular limitation is imposed on the blower 120 that may be used in the digital label printer in the present embodiment, turbo fans and conventional blowers are easy to use. To prevent dust from adhering, it is preferable to use a suitable filter in combination.

The air blown by the blower 120 has a temperature of preferably at least 25° C. but not more than 60° C., and more preferably at least 25° C. but not more than 40° C.

By setting the temperature of the blown air within this range, the fluidity can be increased without causing the undercoat liquid to react, thus advantageously smoothing the surface of the undercoat. If the undercoat liquid should react under the influence of heat, the surface layer will end up curing, making it impossible to properly achieve the effect of having only the interior be cured by the UV irradiator 118.

The quantity, velocity and other properties of the draft of air that is made to act on the undercoat by the blower 120 may be suitably selected according to the undercoat to which the draft will be applied. The shape and other properties of the air ejection outlet may also be selected as appropriate.

The recording heads 136Y, 136C, 136M and 136K are arranged, from the upstream to the downstream side in the direction of travel of the recording medium P, in the following order: recording head 136Y, recording head 136C, recording head 136M, recording head 136K.

The recording heads 136Y, 136C, 136M and 136K are full-line type piezoelectric ink-jet heads having a large number of ejection nozzles (nozzles or ink ejecting portions) for ejecting the ink arrayed at fixed intervals over the entire width of the recording medium P (that is, orthogonal to the direction of travel of the recording medium P), and are connected to a head drive controller 192 of the subsequently described control unit 112 and an ink storage/loading section (not shown). The head drive controller 192 controls the amount and timing of ink droplet ejection at the recording heads 136Y, 136C, 136M and 136K.

As the recording medium P is transported by the transport section 110, inks of the respective colors are ejected onto the recording medium P from the recording heads 136Y, 136C, 136M and 136K, thereby forming a color image on the surface of the recording medium P.

In this embodiment, the recording heads are not limited to piezo elements (piezoelectric elements). Any of various systems may be used in place of a piezo system, such as a thermal jet system which uses a heating element such as a heater to heat ink and generate bubbles. In this latter system, the pressure of the bubbles propels the droplets of ink.

The inks ejected from the respective recording heads 136Y, 136C, 136M and 136K in this embodiment are UV-curable inks.

For each of the recording heads 136Y, 136C and 136M, a UV irradiator 138, which is an active energy-irradiating light source, is disposed on the downstream side of each recording head 136Y, 136C or 136M. In addition, another UV irradiator 139 is disposed on the downstream side of the recording head 136K. Various types of ultraviolet light sources, such as metal halide lamps, high-pressure mercury vapor lamps and ultraviolet LEDs may be used as the UV irradiators 118, 138 and 139.

The UV irradiators 138 and 139 expose to ultraviolet light the recording medium P which has passed recording positions facing the respective recording heads 136Y, 136C, 136M and 136K and on which an image has been formed.

Immediately after ink has been ejected from the recording heads and deposited on the surface of the recording medium P, the UV irradiators 138 irradiate the ink on the surface of the recording medium P with energy for semi-curing the ink (e.g., energy for curing only the interior of the ink), thereby curing the ink on the surface of the recording medium P.

In the practice of the invention, as in the case of the undercoat liquid, “semi-curing the ink” signifies partial curing, and refers to a state where the liquid ink (i.e., ink, colored liquid) is in a partially cured, but not a completely cured, state. When the ink liquid ejected onto the undercoat liquid is semi-cured, the degree of cure may be non-uniform; preferably, the degree of curing proceeds in the depth direction of the ink liquid. In the present embodiment, the ink that is to be semi-cured is in the form of ink droplets which land on the undercoat or recording medium and form an ink layer.

When this ink is semi-cured and an ink of a different hue is deposited on top of the semi-cured ink, there can be achieved a technical effect which is advantageous to the quality of the resulting print. The mechanism of action may be confirmed by examining a cross-section of the print.

Semi-curing of the ink (i.e., the ink droplets which have landed on the recording medium or the undercoat, or the ink layer formed from ink droplets which have landed) is explained below.

FIG. 6 is a schematic sectional view of a recording medium where a second ink d_{b} has been deposited onto a semi-cured first ink dₐ. FIGS. 7A and 7B are schematic sectional views of recording media where droplets of the second ink d_{b} have been deposited onto the first ink dₐ that is in an uncured state, and FIG. 7C is a schematic sectional view of a recording medium where droplets of the second ink d_{b} have been deposited onto the first ink dₐ that is in a completely cured state.

When a secondary color is formed by depositing droplets of the second ink d_{b} onto the first ink dₐ that has been earlier deposited as droplets, it is preferable to apply the second ink d_{b} onto the first ink dₐ with the latter in a semi-cured state.

Here, the “semi-cured state” of the first ink dₐ is similar to the above-described semi-cured state of the undercoat liquid. As shown in FIG. 6, this is a state where, when the second ink d_{b} is deposited as droplets onto the first ink dₐ, (1) a portion of the second ink d_{b} emerges at the surface of the first ink dₐ, (2) a portion of the second ink d_{b} lies within the first ink dₐ, and (3) the first ink dₐ is present below the second ink d_{b}.

By semi-curing the ink in this way, a cured film (colored film A) of the first ink dₐ and a cured film (colored film B) of the second ink d_{b} can be suitably superimposed, enabling good color reproduction to be achieved.

By contrast, when the second ink d_{b} is deposited as droplets on the first ink dₐ with the latter in an uncured state, either or both of the following occurs: all of the second ink d_{b} lies within the first ink dₐ as shown in FIG. 7A; a state arises where, as shown in FIG. 7B, the first ink dₐ is not present below the second ink d_{b}. In this case, even when the second ink d_{b} is applied to a high density, the droplets are independent of each other, causing the color saturation of the secondary color to decrease.

When the second ink d_{b} is deposited as droplets on the first ink dₐ which is completely cured, as shown in FIG. 7C, a state will arise where the second ink d_{b} does not lie within the first ink dₐ. This causes interference in the deposition of the droplets to arise, as a result of which a uniform ink film cannot be formed, leading to a decline in color reproducibility.

Here, when the droplets of the second ink d_{b} are applied to a high density, the droplets are not independent of each other. To form a uniform film of the second ink d_{b}, and also to suppress the occurrence of deposition interference, the quantity of regions where the first ink dₐ is uncured per unit surface area is preferably smaller, and more preferably substantially smaller, than the maximum quantity of droplets of the second ink d_{b} applied thereon per unit surface area. That is, the relationship between the weight M_{da} (also referred to as M_{ink A}) of uncured regions of the first ink dₐ layer per unit surface area and the maximum weight m_{db} (also referred to as m_{ink B}) of the second ink d_{b} ejected thereon per unit surface area preferably satisfies the condition (m_{db}/30)<M_{da}<m_{db}, more preferably satisfies the condition (m_{db}/20)<M_{da}<(m_{db}/3), and most preferably satisfies the condition (m_{db}/10)<M_{da}<(m_{db}/5).

By letting (m_{db}/30)<M_{da}, deposition interference can be prevented from occurring. Moreover, a high dot size reproducibility can be achieved. By letting M_{da}<m_{db}, a film of the first ink dₐ can be uniformly formed and a decrease in density can be prevented.

Here, as in the case of the undercoat liquid described above, the weight of the uncured regions of the first ink dₐ per unit surface area is determined by a transfer test. Specifically, after completion of the semi-curing step (e.g., after exposure to active energy rays) and before deposition of the droplets of the second ink d_{b}, a permeable medium such as plain paper is pressed against the layer of the first ink dₐ which is in a semi-cured state, and the quantity of the first ink dₐ that transfers to the permeable medium is determined by weight measurement. The measured value is defined as the weight of the uncured regions of the ink liquid.

For example, if the maximum amount of the second ink d_{b} ejected is set to 12 picoliters per pixel at a deposition density of 600×600 dpi, the maximum weight m_{db} of the second ink d_{b} ejected per unit surface area becomes 0.74 mg/cm² (assuming the density of the second ink d_{b} to be about 1.1 g/cm³). Therefore, in this case, the weight M_{da} per unit surface area of uncured regions of the first ink dₐ layer is preferably greater than 0.025 mg/cm² but less than 0.74 mg/cm², more preferably greater than 0.037 mg/cm² but less than 0.25 mg/cm², and most preferably greater than 0.074 mg/cm² but less than 0.148 mg/cm².

In addition, the subsequent UV irradiator 139 more completely cures the undercoat that has been semi-cured (e.g., cured at the interior only) by the UV irradiator 118 and the respective color ink layers that have been formed thereon and semi-cured (e.g., cured at the interior only) by the earlier UV irradiators 138. The image-recording section 102 of the digital label printer 100 according to the present embodiment thus employs this type of curing process.

It is preferable for the UV irradiators 138 and 139 to be positioned or configured in such a way that the UV light which is emitted irradiates ink on the surface of the recording medium P, but does not irradiate the ink nozzles on the recording heads 136Y, 136C, 136M and 136M. By thus preventing UV light from irradiating the ink nozzles, the ink can be prevented from curing at the nozzles.

Preferably, a measure for preventing light reflection (e.g., matte black treatment) is provided at each of the areas in the vicinity of the UV irradiators 138 and 139.

The image detector 140 and the print defect marker 142 are disposed at a stage subsequent to the recording head unit 135 within the image-recording section 102.

The image detector 140 is composed of an imaging means which uses, for example, a charged coupled device (CCD), and is used to detect whether the image recorded on the surface of the recording medium P is correct by comparing in the control unit 112 image data that has been read with pre-stored data on the image to be formed as will be described later.

The print defect marker 142 is composed of an ink-jet recording head which, when the image detected by the image detector 140 is not a correct image that matches the image to be formed, that is, when the image detected by the image detector 140 is a defective printed image, prints a mark to this effect (e.g., a red cross (x)) on the defective printed image.

The image detector 140 is described above as being composed of an imaging means that uses a CCD, and the printing defect marker 142 is described as being composed of an ink-jet recording head. However, these are both illustrative, non-limiting, examples. In the practice of the invention, the image detector 140 and the printing defect marker 142 may of course be configured in other ways as well.

The surface smoothing section 104 is disposed at a stage subsequent to the image detector 140 and the printing defect marker 142. This surface smoothing section 104 is situated on the downstream side of the image-recording section 102 in the direction of travel of the recording medium P, and has both a varnish coater 143 which is a clear liquid feeding means that feeds to the surface of the recording medium P an active energy-curable (in this embodiment, UV-curable) liquid (also referred to below as “active energy-curable clear liquid” or simply “clear liquid”), and a UV irradiator 148 which is an active energy-irradiating means that cures the clear liquid by exposing it to active energy.

The varnish coater 143 has a pair of coating rolls 144 and 145 to the surface of which adheres (on which has been impregnated) the clear liquid. The coating rolls 144 and 145 are disposed at positions at which the recording medium P transported by the transport section 110 is nipped. The coating rolls 144 and 145 rotate in accordance (synchronous) with movement of the recording medium P while nipping the recording medium P, thereby coating with a clear liquid, following passage through the image-recording section 102 and image formation, the surface of the recording medium P (the surface on which an image has been formed) after the drawing state has been inspected by the image detector 140 and the print defect marker 142.

The clear liquid coated by the varnish coater 143 is an active energy-curable clear liquid which is curable by exposure to ultraviolet light. Exemplary clear liquids include cationic-polymerizable compositions, radical-polymerizable compositions and aqueous compositions which contain as the primary ingredients at least a polymerizable compound and a photoinitiator. The clear liquid is described in detail later in the specification.

The UV irradiator 148 is disposed on the downstream side of the varnish coater 143 in the direction of travel of the recording medium P. The UV irradiator 148 irradiates the recording medium P with active energy (in this embodiment, ultraviolet light), thereby curing the clear liquid which has been coated onto the surface of the recording medium P and smoothed. The UV irradiator 148 is exemplified by metal halide lamps, high-pressure mercury vapor lamps and ultraviolet LEDs.

The varnish coater 143 and the UV irradiator 148, while not devices critical for smoothing the region of the recording medium P to which foil is to be applied, are preferably provided because a good, smooth surface can be obtained when a clear liquid is applied.

As noted above, in this embodiment, a transport buffer is provided between the surface smoothing section 104 and the subsequently described foil stamping section 106.

By providing such a transport buffer, the slack in the recording medium P that arises from a difference in the transport speeds of the surface smoothing section 104 and the foil stamping section 106 can be absorbed, enabling the labels to be efficiently manufactured.

The foil stamping section 106 is situated on the downstream side of the surface smoothing section 104 in the direction of transport of the recording medium P, and includes a foil feed roll 150, a foil take-up roll 152, a first roller 154, a second roller 156, foil 158, and a hot stamping plate 160.

The foil feed roll 150 and the foil take-up roll 152 are disposed so as to be separated by a specific interval. The first roller 154 and the second roller 156 are arranged in such a way as to be separated by a specific interval, such that a plane defined by the rollers 154 and 156 is parallel to the surface of the recording medium P, and at positions more proximate to the recording medium P than the foil feed roll 150 and the foil take-up roll 152. Moreover, the first roller 154 and the second roller 156 are disposed at positions very close to the recording medium P.

The foil 158 is fed out from the foil feed roll 150, passed around the first roller 154 and the second roller 156, and wound onto the foil take-up roll 152. The foil 158 between the first roller 154 and the second roller 156 is made parallel to the recording medium P.

The hot stamping plate (relief plate) 160 is disposed between the first roller 154 and the second roller 156 at a position facing the recording medium P via the foil 158. The face on the recording medium P side of the hot stamping plate 160 is provided with a relief plate portion 160a which is made of a material such as zinc or brass and comes into contact with and foil-stamps the foil 158. In addition, the hot stamping plate 160 has a heater (not shown) which heats the relief plate portion 160a and a transfer mechanism which transfers the hot stamping plate 160 in a direction of moving it closer to or farther from the recording medium P.

The hot stamping plate 160 brings the relief plate portion 160a in a heated state into contact with and presses it against the recording medium P through the foil 158, thereby heat and pressure bonding the foil 158 onto the recording medium P according to the shape of the relief plate portion 160a.

The post-treatment section 108 is disposed on, in the recording medium P travel direction, the downstream side of the image-recording section 102, the surface smoothing section 104 and the foil-stamping section 106. It has a varnish coater 162 and an UV irradiator 164 for coating the image surface with a clear, active energy-curable liquid (in the present embodiment, a clear, UV-curable liquid) and improving the gloss, a die cutter 166 for making label-shaped slits in the recording medium P, and a waste roll 172 for peeling off unnecessary portions of the recording medium P.

The varnish coater 162 is a clear liquid feeding means which feeds an active energy (in this embodiment, ultraviolet light) curable clear liquid (referred to below as “active energy-curable clear liquid” or simply “clear liquid”) to the surface of the recording medium P, and which is situated on the downstream side, in the travel direction of the recording medium P, of the hot stamping plate 160 in the foil-stamping section 106.

The varnish coater 162 has a pair of coating rolls to the surface of which adheres (on which has been impregnated) a UV-curable clear liquid, and which rotate in accordance (synchronous) with movement of the recording medium P while nipping the recording medium P, thereby coating the surface of the foil-stamped recording medium P (the side on which an image has been formed) with the UV-curable clear liquid.

Here, the clear liquid coated by the varnish coater 162 is an active energy-curable clear liquid which can be cured by exposure to ultraviolet light. Exemplary clear liquids include cationic-polymerizable compositions, radical-polymerizable compositions and aqueous compositions which contain as the primary ingredients at least a polymerizable compound and a photoinitiator. The clear liquid is described in detail later in the specification.

The UV irradiator 164 is disposed on the downstream side of the varnish coater 162 in the travel direction of the recording medium P. The UV irradiator 164 irradiates the surface of the recording medium P with active energy (in this embodiment, ultraviolet light), thereby curing the UV-curable clear liquid that has been coated onto the surface of the recording medium P.

The UV-curable clear liquid is coated onto the surface of the recording medium P and cured, enabling luster to be imparted to the image side of the recording medium P and making it possible to improve the image quality.

The die cutter 166 makes slits 180b of a desired label shape in only the pressure-sensitive adhesive sheet 180 of a printed, web-type recording medium P for printing labels, as shown in FIG. 3. The die cutter 166 is situated on the downstream side of the UV irradiator 164 in the travel direction of the recording medium P, and has a cylinder cutter 168 disposed on the image-forming side of the recording medium P and an anvil roller 170 disposed on the opposite side of the recording medium P from the cylinder cutter 168.

The cylinder cutter 168 is composed of a cylinder 168a and a plurality of slitting blades 168b which are wound around the cylindrical surface of the cylinder 168a and are formed according to the shape and arrangement of the labels.

The die cutter 166, while nipping the recording medium P between the cylinder cutter 168 and the anvil roller 170, undergoes an intermittently rocking rotation which is synchronous with the transport speed of the recording medium P, causing the slitting blades 168b to make label-shaped slits in only the pressure-sensitive adhesive sheet 180 of the recording medium P (see FIG. 3).

Here, referring to FIG. 8, if the cylindrical surface of the cylinder 168a has a length CL in the circumferential direction which is not an integral multiple of the length LL of the labels L, that is, if the length CL in the circumferential direction of the cylindrical surface of the cylinder 168a and the length CL1 of the slitting blades 168b do not agree, there arises on the cylindrical surface of the cylinder 168a a blank portion B where the slitting blades 168b cannot be provided.

In this case, when label-shaped slits 180b are formed by continuously rotating the die cutter 166, a large unnecessary portion P1 corresponding to the blank portion B ends up being formed between the group of labels LB in which slits 180b have been formed during the previous rotation of the die cutter 166 and the group of labels LA in which slits 180b have been formed during the present rotation, resulting in the generation of waste in the recording medium P.

In the present embodiment, to eliminate the wasteful formation of unnecessary portions P1 in the recording medium P, the die cutter 166 is made to rotate with an intermittently rocking motion. In this way, as shown in FIG. 9, the next slits 180b can be made at the trailing end of the group of labels LB in which the previous slits 180b were made. In this way, even when the length CL in the circumferential direction of the cylindrical surface of the cylinder 168a is not an integral multiple of the length LL of the labels L, unnecessary portions P1 are not formed between the groups LB and LA of labels L, thus enabling a web-type recording medium P for printing labels to be efficiently used.

The waste roll 172 peels from the peel sheet 182 and takes up unnecessary portions (label borders) of the pressure-sensitive adhesive sheet 180 which do not form labels (finished product) L.

The thus taken up recording medium P after unnecessary portions have been peeled, that is, the recording medium P in a state where only the labels L remain adhering to the peel sheet 182, is then taken up onto the product roll 134, giving the final product.

Next, the control unit 112 which controls the transport section 110, the image-recording section 102, the surface smoothing section 104, the foil-stamping section 106, the post-treatment section 108, the image detector 140 and the print defect marker 142 is described.

As shown in FIG. 2, the control unit 112 has a memory 191 which stores recording image data for ink ejection from the recording heads 136Y, 136C, 136M and 136K of the recording head unit 135, a head drive controller 192 for controlling the drive of the recording heads 136Y, 136C, 136M and 136K of the recording head unit 135 based on the recording image data, an image data analyzer 193 for analyzing the shapes of the labels L based on the image data stored in the memory 191, a transport speed changer 194 for changing the transport speed of the web-type recording medium P for printing labels based on the shapes of the labels L analyzed by the image data analyzer 193, a transport motor controller 195 for controlling the rotational speed of the transport motors 126a and 134a based on the transport speed changed by the transport speed changer 194, a die cutter controller 196 for controlling the rotational speed of the die cutter 166 based on the transport speed changed by the transport speed changer 194, an image detection controller 197 for comparing the printed image on the label surface that has been read by the image detector 140 with the specified image data, and a marking controller 198 for applying a mark to a label having a printing defect when a label with a printing defect has been detected by the image detection controller 197.

In addition, an input unit 199 such as a computer is connected to the memory 191 of the control unit 112. The memory 191 stores recording image data that has been input from the input unit 199.

The head drive controller 192, based on the image data stored in the memory 191, selects ink droplet-ejection nozzles in the recording heads 136Y, 136C, 136M and 136K of the recording head unit 135, computes the amount of ink droplets to be ejected, the ejection timing and other parameters, and controls the recording head unit 135 based on the computation results. To illustrate, in the case of piezoelectric ink-jet heads such as those in the present embodiment, the piezoelectric element to which a voltage will be applied is selected from among a plurality of ejection portions (nozzles), the voltage to be applied, the period of application and the timing of such application are computed and ejection signals are sent to the recording heads 136Y, 136C, 136M and 136K based on the computation results.

The image data analyzer 193 analyzes the shape of a label L from label edge data among the image data stored in the memory 191, and sends the results of analysis to the transport speed changer 194.

The transport speed changer 194 has pre-stored therein the transport speed optimal to post-treatment for each label L shape. Based on both the shape of the label L computed from the label edge data analyzed by and received from the image data analyzer 193 and the stored transport speed, the transport speed changer 194 computes the optimal transport speed of the recording medium P and sends the computation results to the transport motor controller 195 and the die cutter controller 196.

The transport motor controller 195 controls the rotational speeds of the transport motors 126a and 134a based on the optimal transport speed computed by the transport speed changer 194. In this way, the web-type recording medium P for printing labels is transported at the optimal speed.

The die cutter controller 196 controls the rotational speed of the die cutter 166 based on the optimal transport speed computed by the transport speed changer 194. Specifically, the die cutter controller 196 controls the rotational speed of the die cutter 166 so that the transport speed of the recording medium P and the circumferential velocity of the slitting blades 168b on the die cutter 166 are the same.

The control unit 112 thus changes or regulates, based on label shape data calculated from the label edge data, the transport speed of the recording medium P which is transported through the post-treatment section 108.

In addition, it is preferable for the transport speed changer 194 to control, based on the label L shape data, the transport speed of the recording medium P so as to slow the speed at positions of label portions that are vulnerable to the peeling of unnecessary portions. This helps prevent breakage or rupture from occurring when the waste is removed, enabling the reliable removal of unnecessary portions other than the label portions.

The conditions under which breakage or rupture tend to occur when unnecessary portions are peeled off differ depending on the material of which the pressure-sensitive adhesive paper is made. For example, breakage or rupture may occur when the width of the unnecessary portions is not more than 5 mm or when such portions have an acute angle of not more than 30°. It is advantageous to set in the transport speed changer 194 optimal peel rates that have been determined beforehand empirically under various conditions and to compute the optimal transport speed of the recording medium P while also taking into account these optimal peel rates.

Next, a method for producing labels with the digital label printer 100 is described. Referring to FIG. 1, the recording medium P that has been let out from the feed roll 122 onto which it is wound into a roll is transported by the transport section 110 to the undercoat-forming section 114 and the image-recording section 102.

In the undercoat-forming section 114, an undercoat liquid is applied to the surface of the recording medium P with the roll coater 116, the surface condition of the undercoat liquid after application is improved with the blower 120, and only the interior of the undercoat liquid after coating is cured with the UV irradiator 118 to form an undercoat.

Next, the recording heads 136Y, 136C, 136M and 136K eject, under control of the control unit 112, droplets of UV-curable ink onto the recording medium P passing positions opposed thereto. The recording medium P onto which the ink has been ejected then travels further and passes positions opposite the UV irradiators 138 and 139, where it is irradiated with ultraviolet light, thereby curing the ink.

That is, when the recording medium P passes positions opposite the recording heads 136Y, 136C, 136M and 136K, ink droplets are ejected onto the recording medium P from the recording heads 136Y, 136C, 136M and 136K. The recording medium P is subsequently exposed to ultraviolet light from the UV irradiators 138 and 139, causing the ink to cure by the process as described above, and thereby forming an image on the surface of the recording medium P.

Next, the image that has been formed on the surface of this recording medium P is read by the image detector 140 and, under the control of the image detection controller 197, this data is compared with image data for the specified label printing image which is stored in the image data analyzer 193. When a label having a printing defect has been detected, the marking controller 198 causes the printing defect marker 142 to place a specific mark indicating a defectively printed product on the label having a printing defect.

The design, size and other attributes of this mark may be set as desired.

The recording medium P on which images have been formed and for which inspection of the printing results has been completed is transported through the transport buffer to the post-treatment section 108, where a UV-curable clear liquid is applied by the varnish coater 162 to the surface of the recording medium P, then is cured by the UV irradiator 164.

The recording medium P that has been coated with the UV-curable clear liquid is transported to the die cutter 166, where slits 180b in the shape of labels L are made only in the pressure-sensitive adhesive sheet 180 by means of the cylinder cutter 168 and the anvil roller 170.

At this time, because the die cutter 166, as noted above, makes slits 180b in the shape of labels L while intermittently rocking, the slits 180b can be continuously formed. Waste from the recording medium P can thus be minimized.

Unnecessary portions (portions other than the labels L) of the pressure-sensitive adhesive sheet 180 of the recording medium P are peeled from the peel sheet 182 and taken up onto the waste roll 172. The recording medium P on which only the labels L remain affixed to the peel sheet 182 is taken up onto the product roll 134, thereby giving a final product.

In some cases, the labels remaining on the recording medium P on which images have been recorded in the image-recording section 102 and the recorded images have been checked may include labels on which marks indicating a defectively printed product have been made as a result of being read by the image detector 140 and compared with image data for a specified label printing image. In such cases, an inspection worker or the like standing by near the product roll 134 will take appropriate action, such as peeling off the label that has been marked to indicate a defectively printed product and affixing at the same position in its place a correctly printed label.

Such an operation, when compared with conventional operations that rely on visual inspection, greatly reduces the burden on inspection personnel, and thus promises to have major practical effects, including the prevention of inspection errors such as overlooking defective goods, and a reduction in the level of fatigue experienced by inspection workers.

Moreover, the digital label printer 100 of the present embodiment carries out peel processing in which the transport speed changer 194, based on label shape data, slows the transport speed of the recording medium P at positions of label portions which are vulnerable to the peeling of unnecessary portions, thereby preventing the breakage or rupture of the labels L during post-treatment (waste removal) and enabling the reliable removal of unnecessary portions other than the label portions. In this way, halting of the apparatus due to the breakage or rupture of labels L is eliminated, enhancing productivity and making it possible to inexpensively provide labels L.

By providing a surface condition improving means (specifically, the blower 120) which improves the surface condition of the applied undercoat liquid, a level and uniform undercoat can be formed even when a highly viscous liquid is used as the undercoat liquid. Moreover, the undercoat liquid applied by the surface condition improving means can be rendered into a level and uniform undercoat within a short period of time. Prints having a high image quality can be rapidly produced in this way.

By forming an undercoat on a recording medium and semi-curing the undercoat liquid as in the present embodiment, even when ink droplets having portions which mutually overlap are deposited on the recording medium, the coalescence of these neighboring ink droplets can be suppressed through interactions between the undercoat liquid and the ink droplets.

That is, by forming a semi-cured undercoat on the recording medium, the migration of ink droplets can be prevented in cases where ink droplets ejected from the recording heads are deposited in close proximity on the recording medium, such as when ink droplets of a single color having portions which mutually overlap are deposited on a recording medium or even when ink droplets of different colors having portions which mutually overlap are deposited on a recording medium.

In this way, image bleed, line width non-uniformities such as of fine lines in the image, and color unevenness on colored surfaces can be effectively prevented from occurring, enabling the formation of uniform-width, sharp line shapes, and thus making it possible to carry out the recording of ink-jet images of a high deposition density, such as reversed letters, with good reproducibility of fine features such as fine lines. That is high-quality images can be formed on the recording medium.

By placing a UV irradiator between the respective recording heads and semi-curing the ink droplets (i.e., the image) deposited onto the recording medium using the respective recording heads, it is possible to prevent different-color ink droplets deposited at adjacent positions from overlapping and to keep the deposited ink droplets from migrating.

When the semi-cured state of the undercoat liquid and/or the ink is realized by a polymerization reaction of the polymerizable compound that is initiated by the irradiation of active energy rays or heating, to enhance the scuff resistance of the print, the unpolymerization ratio (i.e., A_{after polymerization}/A_{before polymerization}) is preferably at least 0.2 but not more than 0.9, more preferably at least 0.3 but not more than 0.9, and most preferably at least 0.5 but not more than 0.9.

Here, A_{before polymerization} is the infrared absorption peak absorbance attributable to polymerizable groups before the polymerization reaction, and A_{after polymerization} is the infrared absorption peak absorbance attributable to polymerizable groups after the polymerization reaction.

For example, when the polymerizable compound included in the undercoat liquid and/or the ink is an acrylate monomer or a methacrylate monomer, absorption peaks based on polymerizable groups (acrylate groups, methacrylate groups) can be observed near 810 cm⁻¹. Accordingly, the above unpolymerization ratio is preferably defined in terms of the absorbances of these peaks. When the polymerizable compound is an oxetane compound, an absorption peak based on polymerizable groups (oxetane rings) can be observed near 986 cm⁻¹. The above unpolymerization ratio is thus preferably defined in terms of the absorbance of this peak. When the polymerizable compound is an epoxy compound, an absorption peak based on the polymerizable groups (epoxy groups) can be observed near 750 cm⁻¹. Hence, the above unpolymerization ratio is preferably defined in terms of the absorbance of this peak.

A commercial infrared spectrophotometer may be used as the means for measuring the infrared absorption spectrum. The spectrophotometer may be either a transmission-type or reflection-type system. Suitable selection according to the form of the sample is preferred. Measurement may be carried out using, for example, an FTS-6000 infrared spectrophotometer manufactured by Bio-Rad.

In the case of a curing reaction based on an ethylenically unsaturated compound or a cyclic ether, the unpolymerization ratio may be quantitatively measured from the percent conversion of ethylenically unsaturated groups or cyclic ether groups.

In the present embodiment, the undercoat liquid and/or the ink are semi-cured by exposure to active energy rays, specifically ultraviolet light. However, the invention is not limited in this regard.

The method used here to semi-cure the undercoat liquid and/or the ink is exemplified by known thickening methods, e.g., (1) methods that use an agglomerating effect, such as by furnishing a basic compound to an acidic polymer or by furnishing an acidic compound and a metal compound to a basic polymer; (2) methods wherein the undercoat liquid and/or the ink is prepared beforehand at a high viscosity, then the viscosity is lowered by adding thereto a low-boiling organic solvent, after which the low-boiling organic solvent is evaporated so as to return the liquid to its original high viscosity; (3) methods in which the undercoat liquid and/or the ink prepared at a high viscosity is first heated, then is cooled so as to return the liquid to its original high viscosity; and (4) methods in which the undercoat liquid and/or the ink is semi-cured through a curing reaction induced by exposing the undercoat liquid and/or the ink to active energy rays or heat. Of these, (4) methods in which the undercoat liquid and/or the ink is semi-cured through a curing reaction induced by exposing the undercoat liquid and/or the ink to active energy rays or heat, as in the present embodiment, are preferred.

“Methods in which the undercoat liquid and/or the ink is semi-cured through a curing reaction induced by exposing the undercoat liquid and/or the ink to active energy rays or heat” refers herein to methods in which the polymerization reaction on polymerizable compounds at the surface of the undercoat liquid and/or the ink furnished to the recording medium is carried out incompletely. At the surface of the undercoat liquid and/or the ink, compared with the interior thereof, the polymerization reaction tends to be inhibited by the influence of oxygen present in air. Therefore, by controlling the conditions of exposure to active energy or heat, it is possible to trigger the reaction for semi-curing the undercoat liquid and/or the ink.

The amount of energy required to semi-cure the undercoat liquid and/or the ink varies with the type and content of polymerization initiator. When the energy is applied by active energy rays, an amount of about 1 to about 500 mJ/cm² is generally preferred. When the energy is applied as heat, from 0.1 to 1 second of heating under temperature conditions where the surface temperature of the recording medium falls within a temperature range of 40 to 80° C. is preferred.

The application of active energy rays or heat, such as with active rays or heating, promotes the generation of active species by decomposition of the polymerization initiator. At the same time, the increase in active species or the rise in temperature promotes the curing reaction through polymerization or crosslinking of polymerizable or crosslinkable materials induced by the active species.

A thickening (rise in thickness) may also be suitably carried out by exposure to active rays or by heating.

Here, the transport speed of the recording medium P by the transport section 110 is preferably set to at least 200 mm/s but not more than 600 mm/s. By setting the transport speed within the above range, the surface of the undercoat liquid can be made smoother and high-quality images can be efficiently formed on the recording medium. Moreover, prints can be created at a high speed. In other words, it becomes possible to print a large amount of recording medium in a short period of time.

It is preferable for the coated surface state-improving means to be, as in the present embodiment, a blower. The use of a blower enables the surface state of the undercoat liquid to be advantageously improved in a shorter period of time and can lower equipment costs. However, this is not the sole case of the invention but various other devices which smoothen liquid surfaces may be employed.

In the present embodiment, the undercoat liquid is applied onto the recording medium P with a roll coater, although the invention is not limited in this regard. Illustrative examples of other coating devices that may be used for the same purpose include air doctor coaters, blade coaters, rod coaters, knife coaters, squeeze coaters, impregnation coaters, reverse roll coaters, transfer roll coaters, gravure coaters, kiss roll coaters, cast coaters, spray coaters, curtain coaters and extrusion coaters.

In the practice of the invention, regardless of the specific method used to apply the undercoat liquid, by using the coated surface state-improving means to improve the surface state of the undercoat liquid (i.e., by rendering the surface of the undercoat formed from the undercoat liquid into a smooth state), then semi-curing the undercoat, a higher-quality image can be formed.

In the present embodiment, UV irradiators are disposed for the respective recording heads (i.e., between recording heads for the respective colors) so as to cure the image area on the recording medium each time an image is recorded with each recording head and thus prevent different colored inks from mixing, thereby enabling a higher-quality image to be formed. However, the invention is not limited in this regard. In another possible arrangement, a single ultraviolet irradiator may be disposed for a plurality of recording heads.

For example, as shown in FIG. 10, advantageous use may be made of a digital label printer 101 which does not have ultraviolet irradiators 138 for semi-curing ink on the recording medium P situated between recording heads 136Y, 136C, 136M and 136K, but rather has only a UV irradiator 139 which completely cures the ink and the undercoat liquid.

The digital label printer 101 uses a roll coater 116 to coat the undercoat liquid onto the recording medium P, uses a blower 120 to improve the surface state of the undercoat liquid, and uses a UV irradiator 118 to irradiate the top of the recording medium P with ultraviolet light and thereby semi-cure the undercoat liquid. Next, the recording heads 136Y, 136C, 136M and 136K are used to form an image on the recording medium P. A UV irradiator 139 is then used to irradiate the top of the recording medium P with ultraviolet light so as to cure the ink (i.e., the image) and the undercoat liquid. In this way, even in an arrangement where a UV irradiator is not provided for each recording head, images can be advantageously recorded on the recording medium P.

Moreover, in the present embodiment, the recording head unit includes heads for four colors of Y, C, M, and K. However, the recording head unit may have any of various other combinations of heads, such as heads for five colors consisting of Y, C, M, K plus a special color (X) such as white, or heads for six or more colors including a special color. No particular limitation is imposed on the order in which the recording heads for the respective colors are arranged; any desired order may be used.

The present invention is not limited to arrangements having a plurality of recording heads. The ink-jet recording device may alternatively be one which forms an image on the recording medium using a single recording head, then irradiates the image with ultraviolet light to create a monochrome image.

Another embodiment of a digital label printer is described below while referring to FIGS. 11 and 12.

FIG. 11 is a front view showing in simplified form yet another embodiment of a digital label printer which employs the ink-jet recording device of the invention. FIG. 12 is a block diagram illustrating a control unit for controlling the digital label printer shown in FIG. 11.

A digital label printer 200 shown in FIG. 11 has an arrangement which, aside from a post-treatment section 208, is the same as that of the digital label printer 100 shown in FIG. 1. Like elements in both embodiments are thus denoted by the same reference symbols and repeated explanations of such elements are omitted below. The following description focuses on the distinctive features of the digital label printer 200.

As shown in FIG. 11, the post-treatment section 208 of the digital label printer 200 has a varnish coater 162, a UV irradiator 164, a laser cutter 220, and a waste roll 172. Because the varnish coater 162, the UV irradiator 164 and the waste roll 172 are the same as the varnish coater 162, the UV irradiator 164 and the waste roll 172 in the post-treatment section 108 of the digital label printer 100 shown in FIG. 1, detailed explanations of these elements are omitted below.

The laser cutter 220, like the die cutter 166 of the digital label printer 100 shown in FIG. 1, makes slits 180b of a desired label shape in only the pressure-sensitive adhesive sheet 180 of a printed, web-type recording medium P for printing labels. It is situated between the UV irradiator 164 and the waste roll 172.

The laser cutter 220 shines a laser at the traveling web-type recording medium P for printing labels, making label-shaped slits 180b in only the pressure-sensitive adhesive sheet 180.

As shown in FIG. 12, a control unit 212 has a memory 191 which holds recording image data for ink ejection from recording heads 136Y, 136C, 136M and 136K of a recording head unit 135, a head drive controller 192 which sends the image data to be recorded to the recording heads 136Y, 136C, 136M and 136K of the recording head unit 135, an image data analyzer 193a which analyzes the image densities and shapes of the labels L, a transport speed changer 194 which changes the transport speed of the recording medium P based on the shapes of the labels L analyzed by the image data analyzer 193a, a transport motor controller 195 which controls the rotational speed of transport motors 126a and 134a based on the transport speed changed by the transport speed changer 194, an image detection controller 197 which compares the printed image on the label surface that has been read by the image detector 140 with the specified image data, and a marking controller 198 which, when a label with a printing defect has been detected by the image detection controller 197, applies a mark to the label having a printing defect. Hence, the control unit 212 in the present embodiment, aside from differing somewhat in the function of the image data analyzer 193a and having no die cutter controller 196, is of substantially the same construction as the control unit 112 shown in FIG. 2.

The transport speed changer 194 of the control unit 212 in this embodiment computes the transport speed of the recording medium P in accordance with the density in the image density data for the label edges to be cut by the laser cutter 220.

That is, the transport speed changer 194, which has previously stored therein the optimal post-treatment transport speeds for image densities, computes the optimal transport speed based on both the label edge image density that has been analyzed by the image data analyzer 193a and received therefrom and on the transport speeds stored in memory, then sends the computation results to the transport motor controller 195.

Specifically, control is effected so as to slow the transport speed of the recording medium P at positions in the label edge where the image density is high. In this way, in places where the image density is high, that is, where the label L has a high thickness, and which are thus difficult to cut through with a laser, slowing the transport speed allows more energy to be applied, enabling label-shaped slits 180b to be made in the pressure-sensitive adhesive sheet 180.

Here, at the transport speed changer 194, the conditions for setting the transport speed are not limited to the image density (i.e., the ink film thickness). For example, various other properties of the materials, such as the laser light-absorbing properties of the ink, may also be taken into account. The optimal transport speed may be determined empirically in advance for various conditions and set in the transport speed changer 194.

The transport motor controller 195 controls the rotational speed of the transport motors 126a and 134a based on the transport speeds that have been changed by the transport speed changer 194. Here, the web-type recording medium P for printing labels is transported at an optimal speed.

Next, a method for producing labels using this digital label printer 200 is described. Image formation in an image-recording section 102 on the surface of the recording medium P that has been let out from a feed roll 122 is carried out in the same way as in the above-described digital label printer 100.

The recording medium P on which an image has been formed passes through a transport buffer and is transported to the post-treatment section 208, where a UV-curable clear liquid is coated onto the surface of the recording medium P using the varnish coater 162, then cured using the UV irradiator 164.

The recording medium P on which the UV-curable clear liquid has been coated is transported to the laser cutter 220, where it is irradiated with a laser so as to form slits 180b in the shape of labels L only in the pressure-sensitive adhesive sheet 180.

Next, unnecessary portions (portions other than the labels L) of the pressure-sensitive adhesive sheet 180 of the recording medium P are peeled from the peel sheet 182 and taken up by the waste roll 172. The recording medium P on which only the labels L remain affixed to the peel sheet 182 is wound onto a product roll 134, thereby giving a final product.

Here, in laser cutting, it is necessary to increase the energy in accordance with the thickness of the label L. The thicker the label L, the more energy is required.

When an active energy-curable ink is used, the cured ink that is formed on the pressure-sensitive adhesive sheet 180 swells outward. The swell height of the cured ink may be, for example, about 12 μm. In a color printed area where a plurality of inks (Y, M, C) are deposited on top of each other, this height becomes even greater. When active energy-curable ink is employed, because recording media P which do not absorb any ink whatsoever are commonly employed, the swell height may increase even further. Also, in areas of high image density, a large amount of ink is deposited. Hence, the swell height also increases, resulting in an even greater thickness. The minimum thickness of a recording medium P for printing labels is about 12 μm, which is thinner even than the ink thickness, further increasing the influence of the ink thickness.

The digital label printer 200 of the present embodiment deals with this problem in the post-treatment step by using the transport speed changer 194, which adjusts the transport speed of the recording medium P in accordance with the density in the image density data at the label edges; specifically, slows the transport speed of the recording medium P when cutting thick areas with the laser. By cutting areas where the image density is high and the ink such as active energy-curable ink has a high thickness at a slow speed with the laser cutter 220, slits can be reliably made in only the pressure-sensitive adhesive sheet and locally incomplete cuts can be prevented from occurring.

Because the detection of defectively printed labels and the marking treatment carried out on such labels in the present embodiment are carried out in exactly the same way as in the earlier described embodiment, a description of these steps is omitted here.

Next, a further example of the digital label printer is described below in conjunction with FIG. 13.

FIG. 13 is a front view showing, in simplified form, a still further embodiment of a digital label printer which uses the ink-jet recording device of the invention.

In a digital label printer 300 shown in FIG. 13, the configuration of the respective sections, aside from an image-recording section 102 being integrated with a surface smoothing section 104 and a foil-stamping section 106 being integrated with a post-treatment section 208—each of the resulting integrated units being furnished as independent and discrete apparatus, is substantially the same as that of the digital label printer 200 shown in FIG. 11. Like elements in both embodiments are thus denoted by the same reference symbols and repeated explanations of such elements are omitted below. The following description focuses on the distinctive features of the present digital label printer 300.

As shown in FIG. 13, the digital label printer 300 has a front-end processing unit 301 which includes the image-recording section 102 and the surface smoothing section 104, and a back-end processing unit 302 which includes the foil-stamping section 106 and the post-treatment section 208.

A method for producing labels using the digital label printer 300 and the elements distinctive of the present digital label printer 300 are described below.

The recording medium P is set on a first feed roll 320 in the front-end processing unit 301, and is transported to an undercoat-forming section 114 and the image-recording section 102 by a pair of transport rollers 126. At the undercoat-forming section 114, an undercoat liquid is applied to the surface of the recording medium P by a roll coater 116, the surface state of the applied undercoat liquid is improved with a blower 120, and only the interior of the applied undercoat liquid is cured using a UV irradiator 118, thereby forming an undercoat.

Next, using recording heads 136Y, 136C, 136M and 136K and UV irradiators 138 and 139, an image is formed on the surface of the recording medium P that has been transported to the image-recording section 102. The recording medium P on which the image has been formed is taken up onto a collecting roll 322. In the present embodiment, a transport motor 322a is provided for the collecting roll 322 so that the collecting roll 322 serves as a drive roller.

The recording medium P on which the image has been formed, i.e., the recording medium P that has been taken up onto the collecting roll 322, is then set on a second feed roll 324 in the back-end processing unit 302. The recording medium P that has been set on the second feed roll 324 is transported by transport roller pairs 130 and 132 to the back-end processing unit 302.

The recording medium P on which the image has been formed has a UV-curable clear liquid applied thereto with a varnish coater 162, following which the recording medium P is irradiated with ultraviolet light at a UV irradiator 164, thereby curing the UV-curable clear liquid that has been applied.

Next, the recording medium P passes by a laser cutter 220 where slits 180b corresponding to the shape of the labels L are made in only the pressure-sensitive adhesive sheet 180 by the laser cutter 220, after which unnecessary portions of the pressure-sensitive adhesive sheet 180 of the recording medium P are peeled from the peel sheet 182 and wound onto a waste roll 172. At the same time, the recording medium P from which the unnecessary portions have been removed so as to leave only the label portions of the pressure-sensitive adhesive sheet 180 and the peel sheet 182, is wound onto a product roll 134, thereby giving a finished product.

In this embodiment as well, a transport speed changer 194 computes the optimal transport speed based on the label edge image density analyzed by an image data analyzer 193a. A transport motor controller 195 controls the rotational speed of a transport motor 134a to the optimal transport speed that has been computed, and carries out transport of the recording medium P. That is, when the laser cutter 220 is used to cut areas where the label edges have a high image density, the transport motor controller 195 carries out control that slows the transport speed of the recording medium P.

In this way, by configuring the digital label printer as separate front-end and back-end processing units, the front-end processing steps of printing the labels L and smoothing the image surfaces, and the back-end processing steps of foil-stamping, clear liquid coating (glossy surface formation), slitting and waste removal can be carried out as separate operations, enabling the back-end processing of numerous different types of labels L to be carried out collectively.

The time required for printing is generally longer than the time required for waste removal and other back-end processing steps. Hence, a single back-end processing unit 302 is able to handle the output from a plurality of front-end processing units 301, making efficient processing possible.

Even in cases where the units are separated in this way, by controlling the transport speed in accordance with values obtained by computation based on image data, the labels formed on the pressure-sensitive adhesive sheet 180 can be precisely cut away from the surrounding unnecessary portions.

Although not shown, in this embodiment as well, as in the embodiment shown in FIG. 12, the control unit has a memory 191 which holds recording image data for ink ejection from the recording heads 136Y, 136C, 136M and 136K of a recording head unit 135, a head drive controller 192 which sends the image data to be recorded to the recording heads 136Y, 136C, 136M and 136K of the recording head unit 135, the image data analyzer 193a which analyzes the image densities and shapes of the labels L, the transport speed changer 194 which changes the transport speed of the recording medium P based on the shapes of the labels L analyzed by the image data analyzer 193a, the transport motor controller 195 which controls the rotational speed of the transport motors 322a and 134a based on the transport speed changed by the transport speed changer 194, an image detection controller 197 which compares the printed image on the label surface that has been read by the image detector 140 with the specified image data, and a marking controller 198 which, when a label with a printing defect has been detected by the image detection controller 197, applies a mark to the label having a printing defect.

Because the operation in which marks are applied to defectively printed labels is carried out in exactly the same way as in the other embodiments described above, an explanation of this operation is omitted here.

In yet another embodiment, as shown in FIG. 14, instead of the die cutter controller 196 which controls the rotational speed of the die cutter 166 based on the transport speed changed by the transport speed changer 194 in the control unit 112 shown in FIG. 2, there is provided a laser cutter controller 196a which controls the laser output of the laser cutter 220 based on the label L image analyzed by the image data analyzer 193a.

The operation of this embodiment differs somewhat from that of the other embodiments described above. As in the above embodiments, marks are applied to labels having printing defects by the marking controller 198 when the image detection controller 197 has detected a defectively printed label after comparing the printed image on a label surface read by the image detector 140 with the specified image data. In the control unit 312 of the present embodiment, the marks are detected by an image detector 140a which is additionally disposed prior to the laser cutter 220, and control is carried out by the laser cutter controller 196a so as not to operate the laser cutter 220 for the defectively printed labels.

Hence, in this embodiment, when unnecessary portions of the pressure-sensitive adhesive sheet of the recording medium P are peeled from the peel sheet 182 and taken up onto the waste roll 172, because slits have not been made in the defectively printed labels, these too are peeled off and removed together with the unnecessary portions, as a result of which the positions where the defectively printed labels were located become blank regions. Therefore, when an inspection worker at this station finds a defectively printed label, there is no need for the worker to peel off the defective label. All that needs to be done is to affix a correctly printed label in the blank region.

In this embodiment, the digital label printer has been described as a UV-curable ink-jet head label printer. However, the invention is not limited to this. Similar effects may be achieved using any type of printer.

Also, in the present embodiment, UV-curable ink and UV-curable clear liquid were used as the undercoat liquid, ink and clear liquid, and an ultraviolet light source was used as the light source for curing the undercoat liquid, ink and clear liquid. However, the invention is not limited to these alone. Various types of active energy-curable undercoat liquids, inks and clear liquids may be used for the undercoat liquid, ink and clear liquid. Similarly, any light source which applies active energy may be used as the light source for curing the undercoat liquid, ink and clear liquid.

As used herein, “active energy” is not subject to any particular limitation, provided the irradiation thereof is capable of conferring energy which may generate initiating species in the undercoat liquid, ink and clear liquid, and thus broadly encompasses, for example, alpha rays, gamma rays, x-rays, ultraviolet light, visible light and electron beams. Of these, from the standpoint of cure sensitivity and the ready availability of the equipment, ultraviolet light and electron beams are preferred. Ultraviolet light is especially preferred. Accordingly, the active energy-curable undercoat liquids, active energy-curable inks and active energy-curable clear liquids are preferably undercoat liquids, inks and clear liquids which are curable by exposure to ultraviolet light.

Undercoat liquids, inks and clear liquids which may be advantageously used in the ink-jet recording devices of the invention are described below. The undercoat liquids, inks and clear liquids which may be advantageously used in ink-jet image-recording devices that employ active energy-curable ink as in the above-described embodiments, and the active energy which cures the undercoat liquids and inks are also described below in detail. Because active energy-curable clear liquids, aside from containing no colorant, are identical to active energy-curable inks, the following description relates for the most part to both undercoat liquids and inks.

The peak wavelength of the active energy, which depends on the absorption characteristics of the sensitizing dye within the ink (the ink is also referred to below as the “ink composition”), is suitably in a range of, for example, 200 to 650 nm, preferably 300 to 450 nm, and more preferably 350 to 450 nm. In addition, the electron transfer initiation system in the ink used in the invention has a sufficient sensitivity even to low-output active energy. It is therefore appropriate for the active energy output to be for example up to 2,000 mJ/cm², preferably from 10 to 2,000 mJ/cm², more preferably from 20 to 1,000 mJ/cm², and even more preferably from 50 to 800 J/cm². Moreover, it is suitable for the active energy to have an exposure face illuminance (maximum illuminance at surface of recording medium) of, for example, from 10 to 2,000 mW/cm², and preferably from 20 to 1,000 mW/cm².

In particular, in the ink-jet recording device used in the invention, it is preferable for the active energy to have a light-emitting wavelength peak of from 390 to 420 nm and be irradiated from a light-emitting diode which generates ultraviolet light having a maximum illuminance at the surface of the above-described recording medium of from 10 to 1,000 mW/cm².

In the ink-jet image-recording device used in the invention, it is suitable for the active energy to be irradiated onto the ink composition which has been ejected onto the recording medium for a period of from 0.01 to 120 seconds, and preferably from 0.1 to 90 seconds.

Also, in the ink-jet recording device used in the invention, it is advantageous to warm the ink to a given temperature and also to set the length of time from deposition of the ink on the recording medium until exposure to active energy at from 0.01 to 0.5 second, preferably from 0.02 to 0.3 second, and more preferably from 0.03 to 0.15 second. By thus controlling the length of time from deposition of the ink onto the recording medium until exposure to active energy to a very brief period of time, it is possible to prevent the deposited ink from bleeding before it cures.

To obtain a color image using the ink-jet recording device of the invention, it is preferable to superimpose the inks in the order of increasing brightness. By superimposing the inks in this way, the active energy will more readily reach the ink at the bottom, which should make it possible to achieve a good cure sensitivity, a reduction in residual monomer, a reduction in odor, and improved adhesion. Alternatively, irradiation of the active energy may be carried out by exposing the colors at the same time after they have all been ejected, although exposure of the ink for each color is preferable from the standpoint of promoting curing.

Moreover, with active energy-curable inks, it is desirable that the ink to be ejected be set to a fixed temperature as explained above, so it is preferable to employ insulation and warming to carry out temperature control from the ink feed tanks to the recording heads (ink-jet heads). It is preferable for a recording head unit which is heated to be thermally shielded or insulated so that the device is not subject to temperature influences from ambient air. To shorten the printer startup time required for heating or reduce the loss of thermal energy, it is preferable to carry out thermal insulation with respect to other sites and also to give the heating unit overall a small heat capacity.

The active energy sources primarily used include mercury vapor lamps, gas lasers and solid state lasers. Mercury vapor lamps and metal halide lamps are widely used as UV irradiators for curing UV-curable inks. In addition, the substitution of GaN semiconductor-based ultraviolet light-emitting devices for the above-mentioned sources is highly useful both industrially and for the environment. Moreover, because LEDs (UV-LEDs) and LDs (UV-LDs) are small, long-lived, highly efficient and inexpensive, they can be advantageously used as active energy-curable ink-jet irradiation sources (active ray sources).

As noted above, it is also possible to use light-emitting diodes (LEDs) and laser diodes (LDs) as active energy sources. In particular, when a UV source is required, use can be made of ultraviolet LEDs and ultraviolet LDs. For example, Nichia Corporation has marketed a violet LED with a primary emission spectrum having wavelengths between 365 nm and 420 nm. Moreover, when even shorter wavelengths are required, U.S. Pat. No. 6,084,250 discloses an LED capable of emitting active energy that has been centered between 300 nm and 370 nm. Other ultraviolet LEDs are available as well, enabling exposure to be carried out using irradiation from different ultraviolet bands. One type of active energy source that is highly desirable for use in the present invention is the UV-LED. UV-LEDs having a peak wavelength of from 350 to 420 nm are especially preferred.

The various ingredients employed in the inks and undercoat liquids that may be suitably used to work the invention are described below.

Active energy-curable inks which may be advantageously used in the invention include cationic-polymerizable ink compositions, radical-polymerizable ink compositions and aqueous ink compositions.

### (Physical Properties of Ink and Undercoat Liquid)

The physical properties of the ink (droplets) ejected onto the recording medium will differ with the device, although in general the viscosity at 25° C. is preferably from 5 to 100 mPa·s, and more preferably from 10 to 80 mPa·s. The viscosity at 25° C. before internal curing of the undercoat liquid is preferably from 10 to 500 mPa·s, and more preferably from 50 to 300 mPa·s.

In the practice of the invention, in order to form dots of the intended size on the recording medium, it is preferable for the undercoat liquid to include a surfactant, and more preferable that it satisfy conditions (A), (B) and (C) below.
(A) The undercoat liquid has a lower surface tension than any of the inks ejected onto the recording medium.
(B) At least one surfactant included in the undercoat liquid satisfies the relationship

γs(0)−γs(saturation)>0 (mN/m).
(C) The surface tension of the undercoat liquid satisfies the relationship

γs<(γs(0)+γs(saturation)^{max})/2.

Here, γs represents the surface tension of the undercoat liquid, γs (0) is the surface tension of the liquid from which all the surfactants in the undercoat liquid composition have been excluded, γs (saturation) is the surface tension of the liquid obtained by adding one of the surfactants included in the undercoat liquid to the above “liquid from which all the surfactants in the undercoat liquid composition have been excluded” and increasing the concentration of that surfactant until the surface tension reaches saturation, and γs (saturation)^{max} is the largest of the γs (saturation) values obtained for all the surfactants included in the undercoat liquid that satisfy above condition (B).

### Condition (A):

In the practice of the invention, as explained above, to form ink dots of the desired size on the recording medium, it is preferable for the surface tension γs of the undercoat liquid to be lower than the surface tension γk of any of the inks.

Also, to more effectively prevent expansion of the ink dots in the time interval between deposition and exposure, it is more preferable for γs<γk−3 (mN/m), and even more preferable for γs<γk−5 (mN/m).

When a full-color image is formed (printed), to enhance the sharpness of the image, the surface tension γs of the undercoat liquid is preferably lower than the surface tension of an ink containing a colorant having a high luminosity factor, and more preferably lower than the surface tension of all inks. Examples of colorants having a high luminosity factor include colorants which have magenta, black and cyan colors.

Moreover, for proper ejection, the ink surface tension γk and the undercoat liquid surface tension γs should satisfy the above-indicated relationship, with each being preferably within a range of from 15 to 50 mN/m, more preferably within a range of from 18 to 40 mN/m, and most preferably within a range of from 20 to 38 mN/m.

By having the surface tensions for both the ink and the undercoat liquid be at least 15 mN/m, the ink droplets to be ejected by the ink-jet heads can be suitably formed, making it possible to prevent improper ejection from occurring. That is, the ink droplets can be suitably ejected. Also, by having the surface tensions for both the undercoat liquid and the ink be up to 50 mN/m, the wettability with the ink-jet heads can be increased, enabling suitable ejection of the ink droplets. That is, the improper ejection of droplets can be prevented from occurring. By having the surface tensions for both be within a range of from 18 to 40 mN/m, and especially within a range of from 20 to 38 mN/m, the above effects can be better achieved and the ink droplets can be reliably ejected.

In the present embodiment, the surface tensions are values measured by the Wilhelmy plate method at a liquid temperature of 20° C. and 60% relative humidity using a commonly used surface tensiometer (e.g., the CBVP-Z surface tensiometer manufactured by Kyowa Interface Science Co., Ltd.).

### Conditions (B) and (C):

In the present invention, the undercoat liquid preferably includes one or more surfactants. By including one or more surfactants in the undercoat liquid, ink dots of the desired size can be more reliably formed on the recording medium. Moreover, it is preferable for the one or more surfactants included in the undercoat liquid to satisfy the following condition (B).

γs(0)−γs(saturation)>0 mN/m Condition (B)

In addition, it is preferable for the surface tension of the undercoat liquid to satisfy the following condition (C).

γs<(γs(0)+γs(saturation)^{max})/2 Condition (C)

As mentioned above, γs represents the surface tension of the undercoat liquid, γs (0) is the surface tension of the liquid from which all the surfactants in the undercoat liquid composition have been excluded, γs (saturated) is the surface tension of the liquid obtained by adding one of the surfactants included in the undercoat liquid to the above “liquid from which all the surfactants in the undercoat liquid composition have been excluded” and increasing the concentration of that surfactant until the surface tension reaches saturation, and γs (saturation)^{max} is the largest of the γs (saturation) values obtained for all the surfactants included in the undercoat liquid that satisfy above condition (B).

The above γs (0) value is obtained by measuring the surface tension of the liquid from which all the surfactants in the undercoat liquid composition have been excluded. The above γs (saturation) value is obtained by adding to the above “liquid from which all the surfactants in the undercoat liquid composition have been excluded” one of the surfactants included in the undercoat liquid and, while increasing the concentration of that surfactant present in the liquid in increments of 0.01 wt %, measuring the surface tension of the liquid when the amount of change in surface tension with respect to the change in surfactant concentration falls below 0.01 mN/m.

The above values of γs (0), γs (saturation) and γs (saturation)^{max} are described more fully below.

For example, when the ingredients making up the undercoat liquid (Example 1) are a high-boiling solvent (diethyl phthalate, available from Wako Pure Chemical Industries, Ltd.), a polymerizable material (dipropylene glycol diacrylate; available from Akcros Chemicals Ltd.), a polymerization initiator (TPO, Initiator 1 shown below), a fluorocarbon surfactant (Megaface F475, available from Dainippon Ink & Chemicals, Inc.) and a hydrocarbon surfactant (sodium di-(2-ethylhexyl)sulfosuccinate), the γs (0), γs (saturation)¹ (when a fluorocarbon surfactant has been added), γs (saturation)² (when a hydrocarbon surfactant has been added), γs (saturation) and γs (saturation)^{max} values are as indicated below.

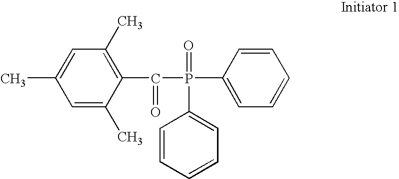

Namely, the value for γs (0), which is the surface tension of the liquid from which all the surfactants in the undercoat liquid have been excluded, is 36.7 mN/m. When the above fluorocarbon surfactant is added to this liquid, the saturation value γs (saturation)¹ for the surface tension of the liquid when the surfactant concentration has been increased is 20.2 mN/m. Similarly, when the hydrocarbon surfactant is added to this liquid, the saturation value γs (saturation)² for the surface tension of the liquid when the surfactant concentration has been increased is 30.5 mN/m.

Because the undercoat liquid (Example 1) includes two types of surfactants which satisfy above condition (B), γs (saturation) can have two values: one for when a fluorocarbon surfactant is added (γs saturation)¹, and another for when a hydrocarbon surfactant is added (γs (saturation)². Because γs (saturation)^{max} is the largest value among γs (saturation)¹ and γs (saturation)², in this case it is the γs (saturation)² value.

The above values are summarized below.

γs (0)=36.7 mN/m

γs (saturation)¹=20.2 mN/m (when fluorocarbon surfactant is added)

γs (saturation)²=30.5 mN/m (when hydrocarbon surfactant is added)

γs (saturation)^{max}=30.5 mN/m

From the above results, it is preferable for the surface tension γs of the undercoat liquid in the foregoing example to satisfy the following relationship:

γs<(γs(0)+γs(saturation)^{max})/2=33.6 mN/m.

With regard to above condition (C), to more effectively prevent ink droplet expansion during the period between deposition and exposure, it is preferable for the surface tension of the undercoat liquid to satisfy the relationship:

γs<γs(0)−3×{γs(0)−γs(saturation)^{max}}/4,

and especially preferable for it to satisfy the relationship:

γs≦γs(saturation)^{max}.

While it suffices for the compositions of the ink and the undercoat liquid to be selected so that the desired surface tension is obtainable, it is preferable for these liquids to include a surfactant. As already explained, to form ink dots of the desired size on the recording medium, it is preferable for the undercoat liquid to include at least one surfactant. A description of the surfactant follows below.

### (Surfactant)

The surfactant used in the invention is typically a substance having a strong surface activity with respect to at least one solvent from among hexane, cyclohexane, p-xylene, toluene, ethyl acetate, methyl ethyl ketone, butyl carbitol, cyclohexanone, triethylene glycol monobutyl ether, 1,2-hexanediol, propylene glycol monomethyl ether, isopropanol, methanol, water, isobornyl acrylate, 1,6-hexanediol diacrylate and polyethylene glycol diacrylate; preferably a substance having a strong surface activity with respect to at least one solvent from among hexane, toluene, propylene glycol monomethyl ether, isobornyl acrylate, 1,6-hexanediol diacrylate and polyethylene glycol diacrylate; more preferably a substance having a strong surface activity with respect to at least one solvent from among propylene glycol monomethyl ether, isobornyl acrylate, 1,6-hexanediol diacrylate and polyethylene glycol diacrylate; and most preferably a substance having a strong surface activity with respect to at least one solvent from among isobornyl acrylate, 1,6-hexanediol diacrylate and polyethylene glycol diacrylate.

Whether or not a particular compound is a substance having a strong surface activity with respect to the solvents listed above can be determined by the following procedure.

One solvent is selected from the solvents listed above, and the surface tension γₛₒₗᵥₑₙₜ (0) for that solvent is measured. The compound is added to the same solvent as that for which γₛₒₗᵥₑₙₜ (0) was determined and, as the concentration of the compound is increased in increments of 0.01 wt %, the surface tension γₛₒₗᵥₑₙₜ (saturation) of the solution when the change in surface tension with respect to the change in compound concentration falls below 0.01 mN/m is measured. If the relationship between γₛₒₗᵥₑₙₜ (0) and γₛₒₗᵥₑₙₜ (saturation) satisfies the condition

γₛₒₗᵥₑₙₜ(0)−γₛₒₗᵥₑₙₜ(saturation)>1 (mN/m),

it can be concluded that the compound is a substance having a strong surface activity with respect to the solvent.

Specific examples of surfactants which may be included in the undercoat liquid include anionic surfactants such as dialkylsulfosuccinic acid salts, alkylnaphthalenesulfonic acid salts, and fatty acid salts; nonionic surfactants such as polyoxyethylene alkyl ethers, polyoxyethylene alkylallyl ethers, acetylene glycols and polyoxyethylene polyoxypropylene block copolymers; cationic surfactants such as alkylamine salts and quaternary ammonium salts; and fluorocarbon surfactants. Other suitable surfactants include those mentioned in, for example, JP 62-173463 A and JP 62-183457 A.

### (Cure Sensitivity of Ink and Undercoat Liquid)

In the practice of the invention, the cure sensitivity of the ink is preferably comparable to or higher than the cure sensitivity of the undercoat liquid. The cure sensitivity of the ink is more preferably higher than the cure sensitivity of the undercoat liquid but not more than four times the cure sensitivity of the undercoat liquid, and even more preferably higher than the cure sensitivity of the undercoat liquid but not more than two times the cure sensitivity of the undercoat liquid.

As used herein, “cure sensitivity” refers to the amount of energy required for complete curing when the ink and/or the undercoat liquid is cured using a mercury vapor lamp (e.g., a ultrahigh-pressure, high-pressure or moderate-pressure mercury-vapor lamp; preferably an ultrahigh-pressure mercury vapor lamp). A smaller amount of energy means a higher cure sensitivity. Accordingly, a two-fold cure sensitivity means that the amount of energy required for complete curing is one-half as large.

Also, reference herein to a cure sensitivity as being “comparable” signifies that the difference in the cure sensitivities of the two liquids being compared is less than 2-fold, and preferably less than 1.5-fold.

### (Recording Medium)

The recording medium used in the ink-jet recording device of the present embodiment may be a permeable recording medium, an impermeable recording medium or a slowly permeable recording medium. Of these, the advantageous effects of the invention can be more clearly achieved with the use of an impermeable or slowly permeable recording medium. As used herein, “permeable recording medium” refers to a recording medium in which, when a 10 pL (picoliter) droplet is deposited on the recording medium, permeation of all the liquid takes not more than 100 ms. “Impermeable recording medium” refers herein to a recording medium in which a droplet substantially does not permeate. “Substantially does not permeate” connotes here a permeability of a droplet after 1 minute of not more than 5%. Also, “slowly permeable recording medium” refers herein to a recording medium in which, when a 10 pL droplet is deposited on the recording medium, permeation of all the liquid takes 100 ms or more.

Illustrative examples of permeable recording media include plain paper, porous paper, and recording media capable of absorbing other liquids.

Illustrative examples of impermeable or slowly permeable recording media include art paper, plastic, rubber, resin-coated paper, glass, metal, ceramic and wood. In the practice of the invention, composite recording media in which a plurality of these materials are combined may also be used for the purpose of adding the functionality thereof.

For plastic recording media, any suitable plastic may be used. Illustrative examples include polyesters such as polyethylene terephthalate and polybutadiene terephthalate; polyolefins such as polyvinyl chloride, polystyrene, polyethylene, polyurethane and polypropylene; and also acrylic resins, polycarbonate, acrylonitrile-butadiene-styrene copolymers, diacetate, triacetate, polyimide, cellophane and celluloid. The thickness and shape of the recording medium when a plastic is used are not subject to any particular limitation. That is, the recording medium may be in the form of a film-like, card-like or block-like shape, and may be either clear or opaque.

It is preferable to use as this plastic recording medium any of various types of film-like, non-absorbing plastics employed in soft packaging, or films made thereof. Illustrative examples of such plastic films include PET films, OPS films, OPP films, PNy films, PVC films, PE films, TAC films and PP films. Other plastics that may be used include polycarbonate, acrylic, ABS, polyacetal and PVA. Use may also be made of rubber.

Illustrative examples of resin-coated paper-type recording media include clear polyester films, opaque polyester films, opaque polyolefin resin films, and paper substrates laminated on both sides with a polyolefin resin. The use of a paper substrate laminated on both sides with a polyolefin resin is especially preferred.

Metal recording media are not subject to any particular limitation. For example, suitable use can be made of aluminum, iron, gold, silver, copper, nickel, titanium, chromium, molybdenum, silicon, lead, zinc and stainless steel, as well as composite materials thereof.

In addition, it is also possible to use as the recording medium read-only optical disks such as CD-ROMs and DVD-ROMs, write-once optical disks such as CD-Rs and DVD-Rs, and rewritable optical disks. In such cases, the image is preferably recorded on the “label” side of the disk.

### (Ink and Undercoat Liquid)

Inks and undercoat liquids suitable for use in the invention are described in detail below.

The ink, which has at least a composition suitable for forming images, includes at least one polymerizable or crosslinkable material, and optionally includes as well a polymerization initiator, a hydrophilic solvent, a colorant and other ingredients.

The undercoat liquid includes at least one polymerizable or crosslinkable material, and optionally includes as well a polymerization initiator, a hydrophilic solvent, a colorant and other ingredients. It is preferable for the undercoat liquid to be formulated so as to have a different composition than the ink.

The polymerization initiator is preferably a compound which is capable of initiating a polymerization reaction or crosslinking reaction under the influence of active energy rays. An undercoat liquid that has been applied to the coating medium can in this way be cured by exposure to active energy rays.

The undercoat liquid and/or the ink preferably includes a radical-polymerizable composition. As used herein, “radical-polymerizable composition” refers to a composition which includes at least one radical-polymerizable material and at least one radical polymerization initiator. Because the undercoat liquid and/or ink includes a radical-polymerizable composition, the undercoat liquid and/or ink curing reaction can be carried out at a high sensitivity in a short period of time.

Moreover, it is preferable for the ink to include a colorant. It is preferable for the undercoat liquid which is used in combination with this ink to either have a composition that includes no colorant or includes less than 1 wt % of colorant, or to have a composition that includes a white pigment as the colorant.

The various ingredients which make up the ink and/or undercoat liquid are described below.

### (Polymerizable or Crosslinkable Material)

The polymerizable or crosslinkable material has the function of triggering a polymerization or crosslinking reaction with initiating species such as radicals generated from, for example, the subsequently described polymerization initiator, and thus causing the composition containing these to cure.

The polymerizable or crosslinkable material employed may be a polymerizable or crosslinkable material which elicits a known polymerizable or crosslinking reaction such as a radical polymerization reaction and a dimerization reaction. Illustrative examples include addition-polymerizable compounds having at least one ethylenically unsaturated double bond, high-molecular-weight compounds having pendant maleimide groups, and high-molecular-weight compounds having a pendant cinnamyl, cinnamylidene or chalcone group with a photodimerizable unsaturated double bond adjacent to an aromatic ring. Of these, an addition-polymerizable compound having at least one ethylenically unsaturated double bond is preferred. Selection from among compounds having at least one, and preferably two or more, terminal ethylenically unsaturated bonds (monofunctional or polyfunctional compounds) is especially preferred. More specifically, suitable selection may be made from among such compounds that are well-known in the industrial field of the invention, including those having the chemical form of, for example, monomers, prepolymers (i.e., dimers, trimers and oligomers) and mixtures thereof, as well as copolymers thereof.

The polymerizable or crosslinkable materials may be used singly or as a combination of two or more thereof.

The use as the polymerizable or crosslinkable material in the invention of, in particular, any of various known radical-polymerizable monomers in which a polymerization reaction is triggered by an initiating species generated from a radical initiator is preferred.

Examples of radical-polymerizable monomers include (meth)acrylates, (meth)acrylamides, aromatic vinyls, vinyl ethers and compounds having internal double bonds (e.g., maleic acid). Here, “(meth)acrylate” refers to either or both “acrylate” and “methacrylate,” and “(meth)acryl” refers to either or both “acryl” and “methacryl.”

[0171-0172]

Illustrative examples of (meth)acrylates are as follows:

Specific examples of monofunctional (meth)acrylates include hexyl (meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, 2-ethyl hexyl diglycol (meth)acrylate, butoxyethyl (meth)acrylate, 2-chloroethyl (meth)acrylate, 4-bromobutyl (meth)acrylate, cyanoethyl (meth)acrylate, benzyl (meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy)ethyl (meth)acrylate, 2-(2-butoxyethoxy)ethyl (meth)acrylate, 2,2,2-trifluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, hydroxyalkyl (meth)acrylate, 2-hydroxyethyl (meth)acrylate, 3-hydroxypropyl (meth)acrylate, 2-hydroxypropyl (meth)acrylate, 2-hydroxybutyl (meth)acrylate, 4-hydroxybutyl (meth)acrylate, dimethylaminoethyl (meth)acrylate, diethylaminoethyl (meth)acrylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethyl ether (meth)acrylate, polyethylene oxide (meth)acrylate, oligoethylene oxide (meth)acrylate, oligoethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligopropylene oxide monoalkyl ether (meth)acrylate, 2-methacryloyloxyethylsuccinic acid, 2-methacryloyloxyhexahydrophthalic acid, 2-methacryloyloxyethyl-2-hydroxypropylphthalate, butoxydiethylene glycol (meth)acrylate, trifluoroethyl (meth)acrylate, perfluorooctylethyl (meth)acrylate, 2-hydroxy-3-phenoxypropyl (meth)acrylate, EO-modified phenol (meth)acrylate, EO-modified cresol (meth)acrylate, EO-modified nonylphenyl (meth)acrylate, PO-modified nonylphenyl (meth)acrylate and EO-modified 2-ethylhexyl (meth)acrylate.

Specific examples of difunctional (meth)acrylates include 1,6-hexanediol di(meth)acrylate, 1,10-decanediol di(meth)acrylate, neopentyl glycol di(meth)acrylate, 2,4-dimethyl-1,5-pentanediol di(meth)acrylate, butylethylpropanediol di(meth)acrylate, ethoxylated cyclohexanemethanol di(meth)acrylate, polyethylene glycol di(meth)acrylate, oligoethylene glycol di(meth)acrylate, ethylene glycol di(meth)acrylate, 2-ethyl-2-butylbutanediol di(meth)acrylate, hydroxypivalic acid neopentyl glycol di(meth)acrylate, EO-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate and tricyclodecane di(meth)acrylate.

Specific examples of trifunctional (meth)acrylates include trimethylolpropane tri(meth)acrylate, trimethylolethane tri(meth)acrylate, the alkylene oxide-modified tri(meth)acrylate of trimethylolpropane, pentaerythritol tri(meth)acrylate, dipentaerythritol tri(meth)acrylate, trimethylolpropane tris((meth)acryloyloxypropyl)ether, isocyanuric acid alkylene oxide-modified tri(meth)acrylate, propionic acid dipentaerythritol tri(meth)acrylate, tris((meth)acryloyloxyethyl)isocyanurate, hydroxypivalaldehyde-modified dimethylolpropane tri(meth)acrylate, sorbitol tri(meth)acrylate, propoxylated trimethylolpropane tri(meth)acrylate and ethoxylated glycerol triacrylate.

Specific examples of tetrafunctional (meth)acrylates include pentaerythritol tetra(meth)acrylate, sorbitol tetra(meth)acrylate, ditrimethylolpropane tetra(meth)acrylate, propionic acid dipentaerythritol tetra(meth)acrylate and ethoxylated pentaerythritol tetra(meth)acrylate.

Specific examples of pentafunctional (meth)acrylates include sorbitol penta(meth)acrylate and dipentaerythritol penta(meth)acrylate.

Specific examples of hexafunctional (meth)acrylates include dipentaerythritol hexa(meth)acrylate, sorbitol hexa(meth)acrylate, the alkylene oxide-modified hexa(meth)acrylate of phosphazene, and captolactone-modified dipentaerythritol hexa(meth)acrylate.

Examples of (meth)acrylamides include (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide and (meth)acryloylmorpholine.

Examples of aromatic vinyls include styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, methyl vinylbenzoate, 3-methylstyrene, 4-methylstyrene, 3-ethylstyrene, 4-ethylstyrene, 3-propylstyrene, 4-propylstyrene, 3-butylstyrene, 4-butylstyrene, 3-hexylstyrene, 4-hexylstyrene, 3-octylstyrene, 4-octylstyrene, 3-(2-ethylhexyl)styrene, 4-(2-ethylhexyl)styrene, allylstyrene, isopropenylstyrene, butenylstyrene, octenylstyrene, 4-t-butoxycarbonylstyrene, 4-methoxystyrene and 4-t-butoxystyrene.

Vinyl ethers are exemplified by monovinyl ethers such as methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexyl methyl vinyl ether, 4-methylcyclohexyl methyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexyl methyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether and phenoxypolyethylene glycol vinyl ether.

Examples of polyvinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether and bisphenol F alkylene oxide divinyl ether; and other polyvinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, ethylene oxide adducts of trimethylolpropane trivinyl ether, propylene oxide adducts of trimethylolpropane trivinyl ether, ethylene oxide adducts of ditrimethylolpropane tetravinyl ether, propylene oxide adducts of ditrimethylolpropane tetravinyl ether, ethylene oxide adducts of pentaerythritol tetravinyl ether, propylene oxide adducts of pentaerythritol tetravinyl ether, ethylene oxide adducts of dipentaerythritol hexavinyl ether and propylene oxide adducts of dipentaerythritol hexavinyl ether.

From the standpoint of such considerations as curability, adhesion to the recording medium and surface hardness of the formed image, it is preferable to use as the vinyl ether compound a di- or trivinyl ether compound. The use of a divinyl ether compound is especially preferred.

In addition to the above, other examples of radical-polymerizable monomers include vinyl esters (e.g., vinyl acetate, vinyl propionate, vinyl versatate), allyl esters (e.g., allyl acetate), halogen-bearing monomers (e.g., vinylidene chloride, vinyl chloride), vinyl cyanides (e.g., (meth)acrylonitrile), and olefins (e.g., ethylene, propylene).

Of the above, from the standpoint of the cure rate, it is preferable to use (meth)acrylates and (meth)acrylamides as the radical-polymerizable monomer. The use of (meth)acrylates having a functionality of 4 or more is especially preferred for achieving a good cure rate. In addition, from the standpoint of the viscosity of the ink composition, the use of a polyfunctional (meth)acrylate in combination with a monofunctional or bifunctional (meth)acrylate or (meth)acrylamide is preferred.

The content of the polymerizable or crosslinkable material in the ink and the undercoat liquid is preferably in a range of 50 to 99.6 wt %, more preferably in a range of 70 to 99.0 wt %, and even more preferably in a range of 80 to 99.0 wt %, based on the weight of the total solids in each droplet.

The content in a droplet, based on the total weight of each droplet, is preferably in a range of 20 to 98 wt %, more preferably in a range of 40 to 95 wt %, and most preferably in a range of 50 to 90 wt %.

### (Polymerization Initiator)

It is preferable for at least the undercoat liquid, or for both the ink and the undercoat liquid, to include at least one polymerization initiator. This initiator is a compound which generates initiating species such as radicals when the energy of active rays, heat or both is applied thereto, thereby initiating and promoting a polymerization or crosslinking reaction of the above-described polymerizable or crosslinkable material so as to effect curing.

The polymerizable material preferably includes a polymerization initiator which triggers radical polymerization. A photopolymerization initiator is especially preferred.

Photopolymerization initiators are compounds which incur a chemical change due to the action of light or to interactions with the electronically excited state of a sensitizing dye, and generates at least one of the following: a radical, an acid or a base. Of such compounds, a photoradical generator is preferred for initiating polymerization by the simple means of exposure to light.

The photopolymerization initiator used in the invention may be suitably selected from among those having sensitivity to the active rays used for exposure, such as 400 nm to 200 nm ultraviolet light, far-ultraviolet light, g-line radiation, h-line radiation, i-line radiation, KrF excimer laser light, ArF excimer laser light, electron beams, x-rays, molecular beams and ion beams.

Any photopolymerization initiator known to those skilled in the art may be used without limitation. Numerous examples are mentioned in, for example, B. M. Monroe et al.: Chemical Revue 93, 435 (1993); R. S. Davidson: Journal of Photochemistry and Biology A: Chemistry 73, 81 (1993); J. P. Faussier: “Photoinitiated Polymerization-Theory and Applications,” in Rapra Review Reports, Vol. 9, Rapra Technology, Ltd. (1998); and M. Tsunooka et al.: Prog. Polym. Sci. 21, 1 (1996). In addition, use may also be made of the group of compounds mentioned in, for example, F. D. Saeva: Topics in Current Chemistry 156, 59 (1990); G. G. Maslak: Topics in Current Chemistry 168, 1 (1993); H. B. Shuster et al.: JACS 112, 6329 (1990); and I. D. F. Eaton et al.: JACS 102, 3298 (1980), which undergo oxidative or reductive bond cleavage through interactions with the electronically excited state of the sensitizing dye.

Preferred photopolymerization initiators include (a) aromatic ketones, (b) aromatic onium salt compounds, (c) organic peroxides, (d) hexaarylbiimidazole compounds, (e) ketoxime ester compounds, (f) borate compounds, (g) azinium compounds, (h) metallocene compounds, (i) active ester compounds, and (j) compounds having carbon-halogen bonds.

Preferred examples of aromatic ketones (a) include the compounds having a benzophenone skeleton or a thioxanthone skeleton mentioned on pages 77 to 117 of Radiation Curing in Polymer Science and Technology by J. P. Fouassier and J. F. Rabek (1993). More preferred examples of aromatic ketones (a) include the α-thiobenzophenone compounds mentioned in JP 47-6416 B, the benzoin ether compounds mentioned in JP 47-3981 B, the α-substituted benzoin compounds mentioned in JP 47-22326 B, the benzoin derivatives mentioned in JP 47-23664 B, the aroylphosphonic acid esters mentioned in JP 57-30704 A, the dialkoxybenzophenones mentioned in JP 60-26483 B, the benzoin ethers mentioned in JP 60-26403 B and 62-81345 A, the α-aminobenzophenones mentioned in JP 1-34242 B, U.S. Pat. No. 4,318,791 and EP 0284561 A, the p-di(dimethylaminobenzoyl) benzenes mentioned in JP 2-211452 A, the thio-substituted aromatic ketones mentioned in JP 61-194062 A, the acylphosphine sulfides mentioned in JP 2-9597 B, the acylphosphines mentioned in JP 2-9596 B, the thioxanthones mentioned in JP 63-61950 B, and the coumarins mentioned in JP 59-42864 B.

Exemplary aromatic onium salt compounds (b) include aromatic onium salts of periodic table group V, VI, and VII elements such as nitrogen, phosphorus, arsenic, antimony, bismuth, oxygen, sulfur, selenium, tellurium and iodine. Preferred examples include iodonium salts mentioned in EP 104143 B, U.S. Pat. No. 4,837,124, JP 2-150848 A and JP 2-96514 A; sulfonium salts mentioned in EP 370693 B, EP 233567 B, EP 297443 B, EP 297442 B, EP 279210 B, EP 422570 B, U.S. Pat. No. 3,902,144, U.S. Pat. No. 4,933,377, U.S. Pat. No. 4,760,013, U.S. Pat. No. 4,734,444 and U.S. Pat. No. 2,833,827; diazonium salts (e.g., benzenediazonium salts which may be substituted), diazonium salt resins (e.g., formaldehyde resins of diazodiphenylamine), N-alkoxypyridinium salts (such as those mentioned in U.S. Pat. No. 4,743,528, JP 63-138345 A, JP 63-142345 A, JP 63-142346 A and JP 46-42363 B, a specific example being 1-methoxy-4-phenylpyridinium tetrafluoroborate), and the compounds mentioned in JP 52-147277 B, JP 52-14278 B and JP 52-14279 B. A radical or an acid is generated as the active species.

Exemplary organic peroxides (c) include substantially all organic compounds having one or more oxygen-oxygen bond in the molecule. For example, it is preferable to use a peroxidized ester such as 3,3′,4,4′-tetrakis(t-butylperoxycarbonyl)benzophenone, 3,3′,4,4′-tetrakis(t-amylperoxycarbonyl)benzophenone, 3,3′,4,4′-tetrakis(t-hexylperoxycarbonyl)benzophenone, 3,3′,4,4′-tetrakis(t-octylperoxycarbonyl)benzophenone, 3,3′,4,4′-tetrakis(cumylperoxycarbonyl)benzophenone, 3,3′,4,4′-tetrakis(p-isopropylcumylperoxycarbonyl)benzophenone and di-t-butyldiperoxyisophthalate.

Exemplary hexaarylbiimidazoles (d) include the lophine dimers mentioned in JP 45-37377B and JP 44-86516 B, such as 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetrakis(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole and 2,2′-bis(o-trifluorophenyl)-4,4′,5,5′-tetraphenylbiimidazole.

Exemplary ketoxime esters (e) include 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoyloxyimino-1-phenylpropan-1-one, 3-p-toluenesulfonyloxyiminobutan-2-one and 2-ethoxycarbonyloxyimino-1-phenylpropane-1-one.

Exemplary borate compounds (f) include the compounds mentioned in U.S. Pat. No. 3,567,453, U.S. Pat. No. 4,343,891, EP 109,772 B and EP 109,773 B.

Exemplary azinium salt compounds (g) include the group of compounds having N—O bonds mentioned in JP 63-138345 A, JP 63-142345 A, JP 63-142346 A, JP 63-143537 A and JP 46-42363 B.

Exemplary metallocene compounds (h) include the titanocene compounds mentioned in JP 59-152396 A, JP 61-151197 A, JP 63-41484 A, JP 2-249 A, JP 2-4705 A, and the iron-arene complexes mentioned in JP 1-304453 A and JP 1-152109 A.

Specific examples of titanocene compounds include dicyclopentadienyl titanium dichloride, dicyclopentadienyl titanium bisphenyl, dicyclopentadienyl titanium bis-2,3,4,5,6-pentafluorophen-1-yl, dicyclopentadienyl titanium bis-2,3,5,6-tetrafluorophen-1-yl, dicyclopentadienyl titanium bis-2,4,6-trifluorophen-1-yl, dicyclopentadienyl titanium 2,6-difluorophen-1-yl, dicyclopentadienyl titanium bis-2,4-difluorophen-1-yl, dimethylcyclopentadienyl titanium bis-2,3,4,5,6-pentafluorophen-1-yl, dimethylcyclopentadienyl titanium bis-2,3,5,6-tetrafluorophen-1-yl, dimethylcyclopentadienyl titanium bis-2,4-difluorophen-1-yl, bis(cyclopentadienyl)-bis(2,6-difluoro-3-(pyr-1-yl)phenyl)titanium, bis(cyclopentadienyl)bis[2,6-difluoro-3-(methylsulfonamide)phenyl]titanium, bis(cyclopentadienyl)bis[2,6-difluoro-3-(N-butylbiaroylamino)phenyl]titanium.

Exemplary active ester compounds (i) include the nitrobenzyl ester compounds mentioned in EP 0290750 B, EP 046083 B, EP 156153 B, EP 271851 B, EP 0388343 B, U.S. Pat. No. 3,901,710, U.S. Pat. No. 4,181,531, JP 60-198538 A and JP 53-133022 A; the iminosulfonate compounds mentioned in EP 0199672 B, EP 84514 B, EP 199672 B, EP 044115 B, EP 0101122 B, U.S. Pat. No. 4,618,564, U.S. Pat. No. 4,371,605, U.S. Pat. No. 4,431,774, JP 64-18143 A, JP 2-245756 A, and JP 4-365048 A; and the compounds mentioned in JP 62-6223 B, JP 63-14340 B and JP 59-174831 A.

Preferred examples of compounds having carbon-halogen bonds (j) include the compounds mentioned by Wakabayashi et al. in Bull. Chem. Soc. Japan 42, 2924 (1969), the compounds mentioned in GB 1388492 B, the compounds mentioned in JP 53-133428 A, and the compounds mentioned in DE 3337024 B.

Additional examples include the compounds mentioned by F. C. Schaefer et al. in J. Org. Chem. 29, 1527 (1964), the compounds mentioned in JP 62-58241 A, the compounds mentioned in JP 5-281728 A, compounds such as those mentioned in DE 2641100 B, the compounds mentioned in DE 3333450 B, the groups of compounds mentioned in DE 3021590 B and the groups of compounds mentioned in DE 3021599 B.

Illustrative, non-limiting examples of the photopolymerization initiator used in the invention include the following compounds.

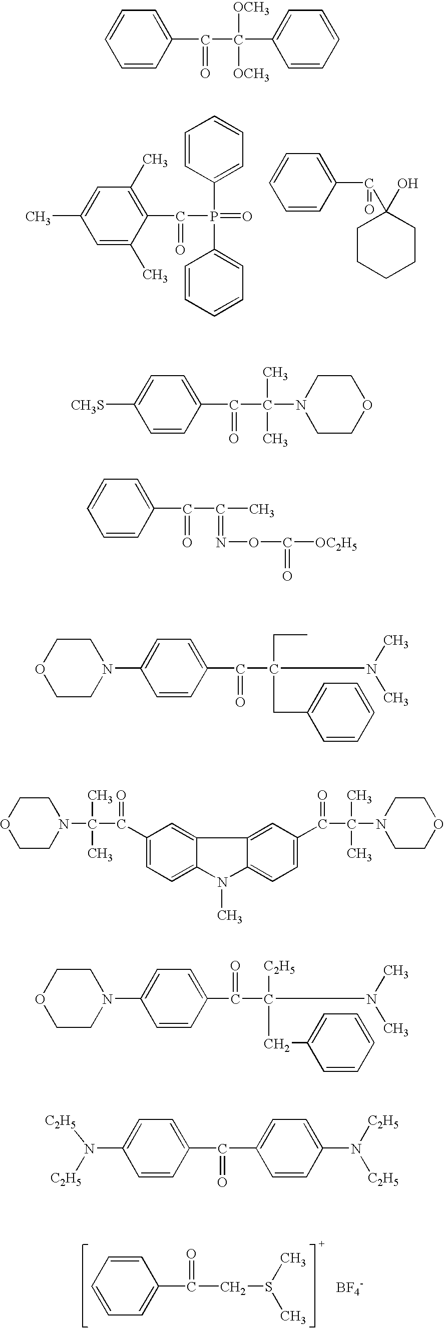

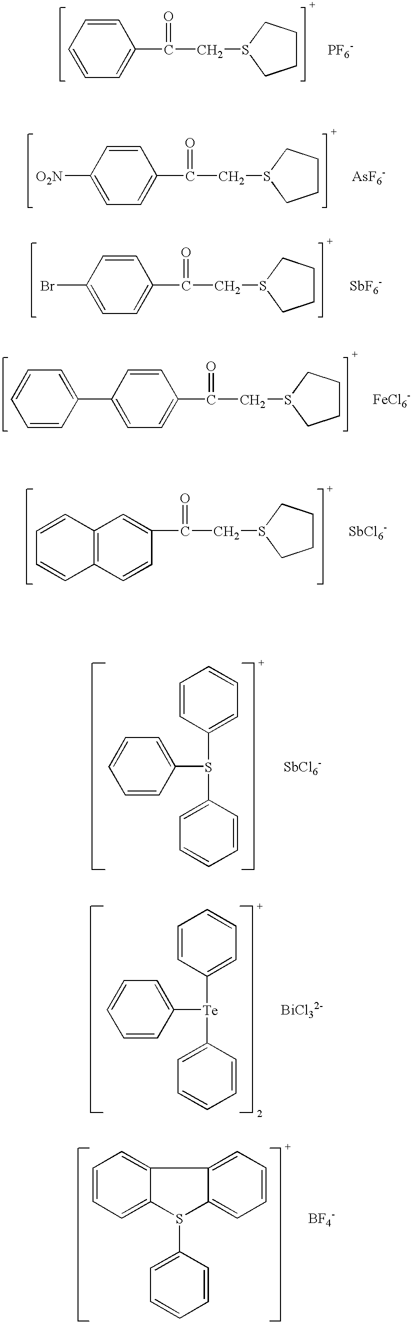

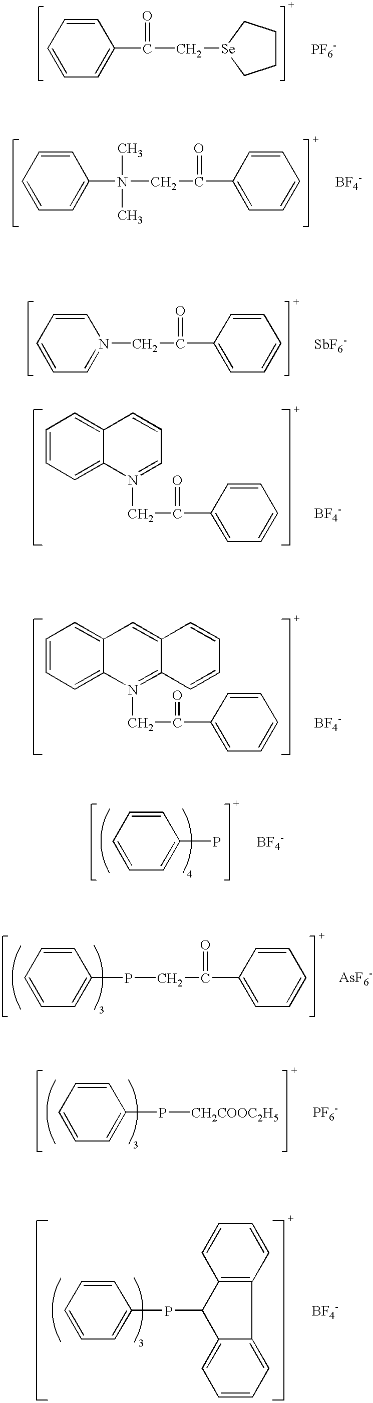

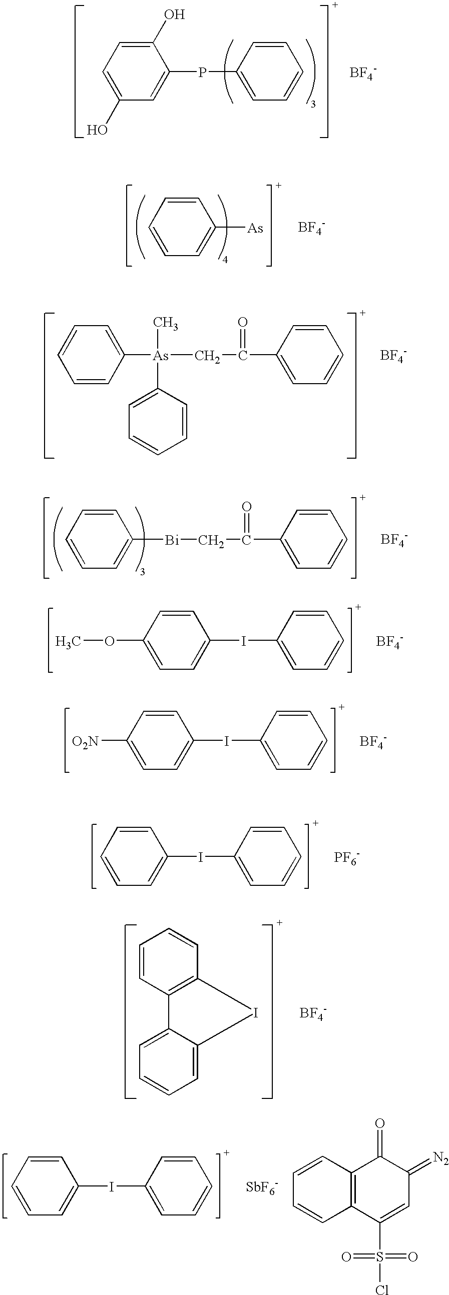

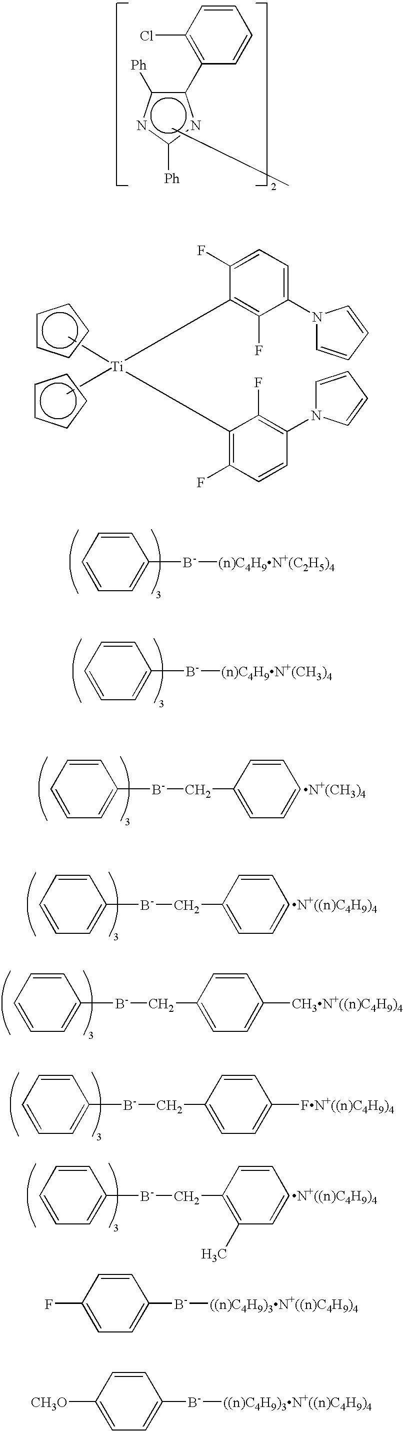

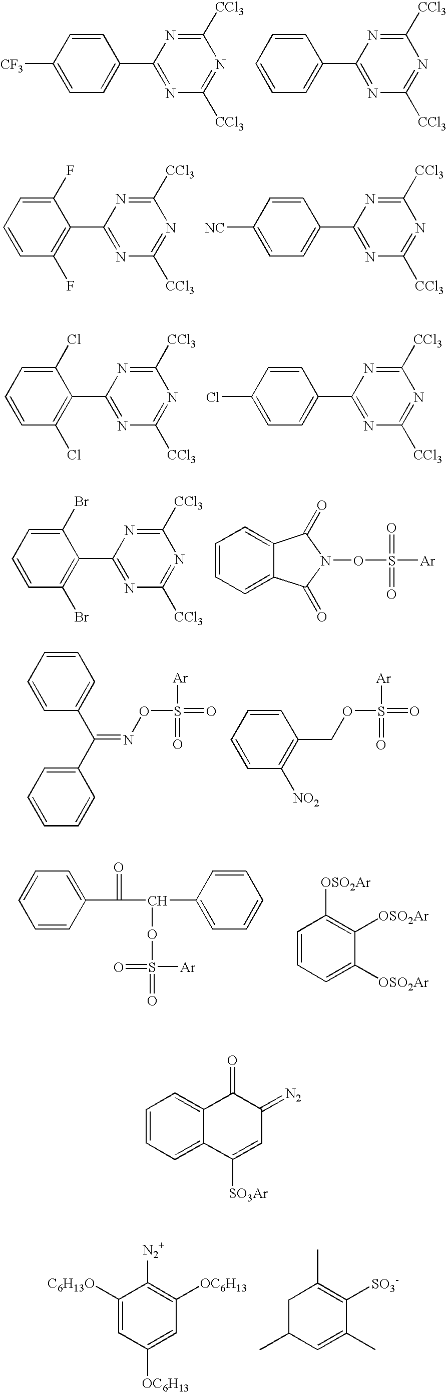

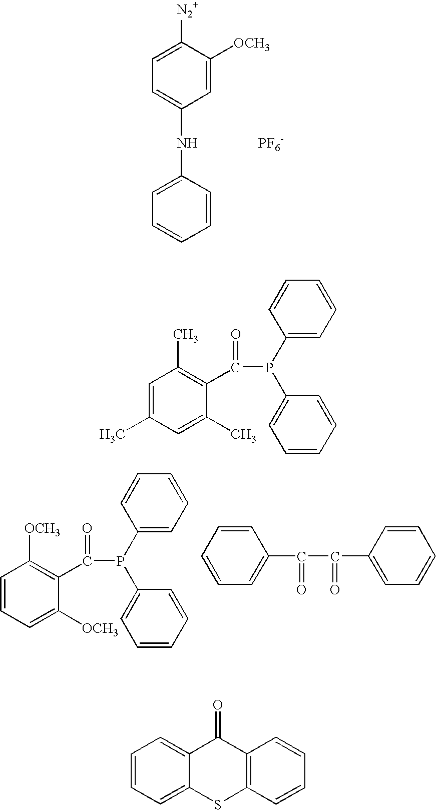

It is desirable for the polymerization initiator to have an excellent sensitivity, although from the standpoint of storage stability, the use of an initiator which does not trigger thermal decomposition at temperatures up to 80° C. is preferred.

The polymerization initiator may be used singly or as a combination of two or more thereof. To enhance the sensitivity, a known sensitizer may be used together with the initiator, insofar as the objects of the invention are attainable.

For a good stability over time, curability and cure rate, the content of the initiator in the undercoat liquid is preferably within a range of 0.5 to 20 wt %, more preferably 1 to 15 wt %, and most preferably 3 to 10 wt %, based on the polymerizable material in the undercoat liquid. By setting the content within the above range, problems such as deposition and separation over time, and deterioration in properties, including the strength and scuff resistance of the ink after curing, can be suppressed.

In addition to being included in the undercoat liquid, the polymerization initiator may also be included in the ink. If such an initiator is included in the ink, the initiator may be suitably selected and included within a range that enables the storage stability of the ink to be maintained at a desired level. In such a case, it is advantageous for the initiator content, based on the polymerizable or crosslinkable compound in the ink, to be set in a range of preferably 0.5 to 20 wt %, and more preferably 1 to 15 wt %.

### (Sensitizing Dye)

It is desirable to add a sensitizing dye to the ink and/or undercoat liquid in order to enhance the sensitivity of the photopolymerization initiator. Preferred sensitizing dyes are exemplified by those compounds among the following which have an absorption wavelength in the range of 350 nm to 450 nm: polycyclic aromatic compounds (e.g., pyrene, perylene, triphenylene), xanthenes (e.g., fluorescein, eosin, erythrosine, rhodamine B, rose bengal), cyanines (e.g., thiacarbocyanine, oxacarbocyanine), merocyanines (e.g., merocyanine, carbomerocyanine), thiazines (e.g., thionine, methylene blue, toluidine blue), acridines (e.g., acridine orange, chloroflavine, acriflavine), anthraquinones (e.g., anthraquinone), squaliums (e.g., squalium) and coumarins (e.g., 7-diethylamino-4-methylcoumarin).

More preferred examples of sensitizing dyes include compounds having the general formulas IX to XIII below.

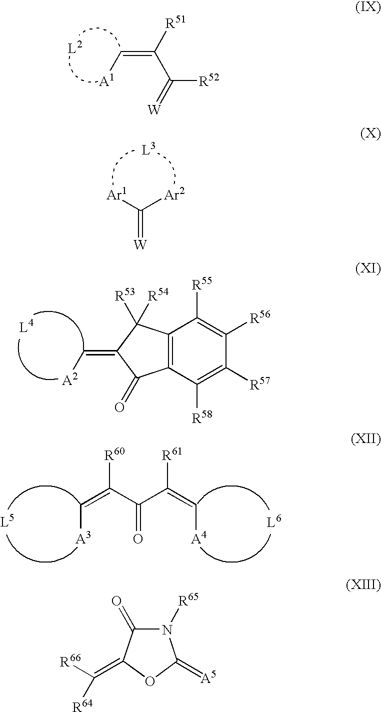

In formula IX, A¹ represents a sulfur atom or —NR⁵⁰—; and R⁵⁰ is an alkyl or aryl group; L² is a non-metallic atomic group which forms, together with the neighboring A¹ and the neighboring carbon atom, the basic nucleus of the dye. R⁵¹ and R⁵² are each independently a hydrogen atom or a monovalent non-metallic atomic group, and may bond together to form the acidic nucleus of the dye. W is an oxygen atom or a sulfur atom.

In formula X, Ar¹ and Ar² are each independently an aryl group, and are linked through -L³-. Here, -L³- represents —O— or —S—. W is the same as in general formula IX.

In formula XI, A² represents a sulfur atom or —NR⁵⁹—, and L⁴ is a non-metallic atomic group which forms, together with the neighboring A and carbon atom, the basic nucleus of the dye. R⁵³, R⁵⁴, R⁵⁵, R⁵⁶, R⁵⁷ and R⁵⁸ are each independently a monovalent non-metallic atomic group, and R⁵⁹ is an alkyl or aryl group.

In formula XII, A³ and A⁴ each independently represent —S—, —NR⁶²— or —NR⁶³—; R⁶² and R⁶³ are each independently a substituted or unsubstituted alkyl group or a substituted or unsubstituted aryl group; L⁵ and L⁶ are each independently a non-metallic atomic group which forms, together with the neighboring A³ and A⁴ and the neighboring carbon atom, the basic nucleus of the dye; and R⁶⁰ and R⁶¹ are each independently a hydrogen atom or a monovalent non-metallic atomic group, or may bond together to form an aliphatic or aromatic ring.

In formula XIII, R⁶⁶ is an aromatic ring or hetero ring which may be substituted; and A⁵ is an oxygen atom, a sulfur atom or —NR⁶⁷—. R⁶⁴, R⁶⁵ and R⁶⁷ are each independently a hydrogen atom or a monovalent non-metallic atomic group, and R⁶⁷ may bond with and R⁶⁵ may bond with R⁶⁷ to form, respectively, an aliphatic or aromatic ring.

Preferred examples of compounds having general formulas IX to XIII include compounds A-1 to A-20 shown below.

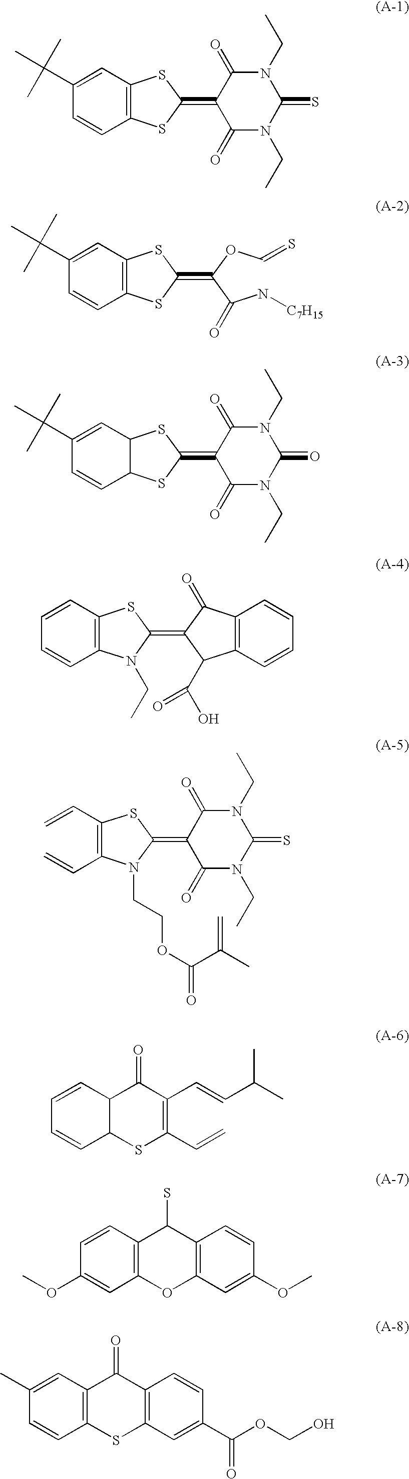

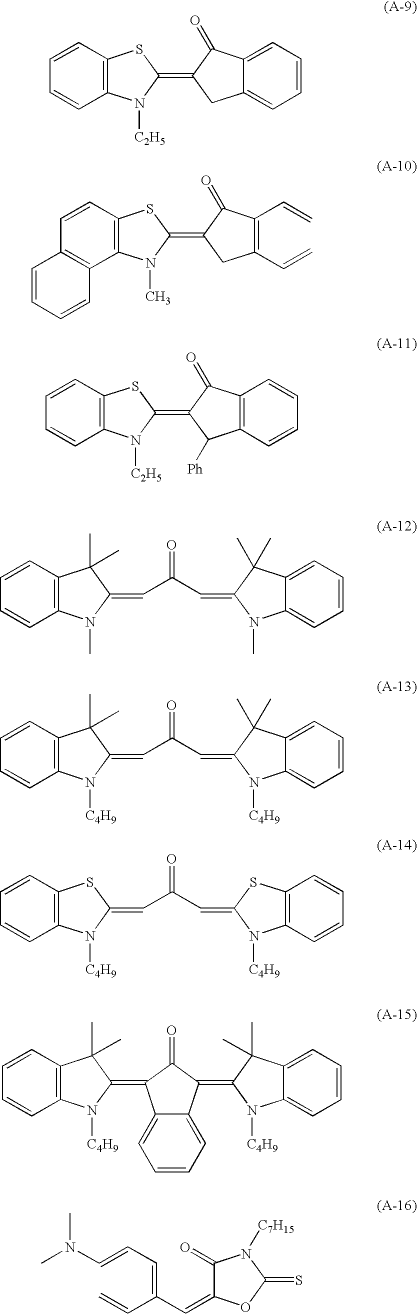

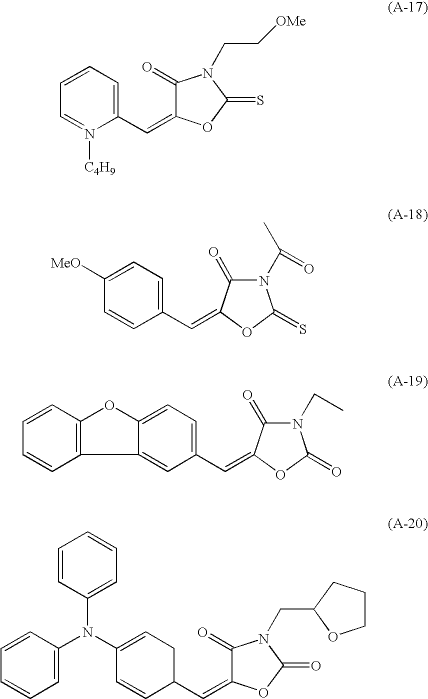

### (Co-Sensitizer)

It is also desirable to add to the ink and/or undercoat liquid, as a co-sensitizer, a known compound which acts to, for example, further enhance the sensitivity or suppress the inhibition of polymerization by oxygen.

Exemplary co-sensitizers include compounds mentioned in, for example, M. R. Sander et al.: Journal of Polymer Society 10, 3173 (1972); JP 44-20189 B, JP 51-82102 A, JP 52-134692 A, JP 59-138205 A, JP 60-84305 A, JP 62-18537 A, JP 64-33104 A, and Research Disclosure 33825. Specific examples include triethanolamine, ethyl p-dimethylaminobenzoate, p-formyldimethylaniline and p-methylthiodimethylaniline.

Other exemplary co-sensitizers include the thiol compounds mentioned in JP 53-702 A, JP 55-500806 B and JP 5-142772 A, and the disulfide compounds mentioned in JP 56-75643 A. Specific examples of these include 2-mercaptobenzothiazole, 2-mercaptobenzoxazole, 2-mercaptobenzimidazole, 2-mercapto-4-(3H)-quinazoline and β-mercaptonaphthalene.

Still further examples include amino acid compounds (e.g., N-phenylglycine), the organometallic compounds mentioned in JP 48-42965 B (e.g., tributyltin acetate), hydrogen donors mentioned in JP 55-34414 B, the sulfur compounds mentioned in JP 6-308727 A (e.g., trithiane), the phosphorus compounds mentioned in JP 6-250387 A (e.g., diethylphosphite) and the Si—H and Ge—H compounds mentioned in JP 8-65779 A.

### (Colorants)

At least the ink, or both the ink and the undercoat liquid, include at least one colorant. Colorants may be included not only in the ink, but also in the undercoat liquid and in other liquids.

The colorants used are not subject to any particular limitation, and may be suitably selected from among, for example, known water-soluble dyes, oil-soluble dyes and pigments. Of these, in cases where the ink and the undercoat liquid are composed of water-insoluble organic solvent systems capable of suitably achieving the objects of the invention, it is preferable for the colorant to be an oil-soluble dye or a pigment which can be easily dispersed or dissolved uniformly in the water-insoluble medium.

The colorant content of the ink is preferably from 1 to 30 wt %, more preferably from 1.5 to 25 wt %, and most preferably from 2 to 15 wt %. When a white pigment is included as a colorant in the undercoat liquid, the colorant content in the undercoat liquid is preferably from 2 to 45 wt %, and more preferably from 4 to 35 wt %.

Pigments suitable for use in the invention are described below.

### Pigments:

The use of a pigment as the colorant is preferred.

The pigment used may be either an organic pigment or an inorganic pigment. Preferred black pigments include carbon black pigments. Black pigments and pigments in the three primary colors of cyan, magenta and yellow are generally used. Pigments having other hues, such as red, green, blue, brown and white; metal luster pigments such as those of gold and silver colors; and colorless or light-colored extender pigments may also be used according to the intended purpose.

Organic pigments are not limited as to their hue. Exemplary organic pigments include perylene, perinone, quinacridone, quinacridonequinone, anthraquinone, anthanthrone, benzimidazolone, disazo condensation, disazo, azo, indanthrone, phthalocyanine, triarylcarbonium, dioxazine, aminoanthraquinone, diketopyrrolopyrrole, thioindigo, isoindoline, isoindolinone, pyranthrone, isoviolanthrone pigments and mixtures thereof.

[0230-0231]

Specific examples include perylene pigments such as C.I. Pigment Red 190 (C.I. No. 71140), C.I. Pigment Red 224 (C.I. No. 71127) and C.I. Pigment Violet 29 (C.I. No. 71129); perinone pigments such as C.I. Pigment Orange 43 (C.I. No. 71105) and C.I. Pigment Red 194 (C.I. No. 71100); quinacridone pigments such as C.I. Pigment Violet 19 (C.I. No. 73900), C.I. Pigment Violet 42, C.I. Pigment Red 122 (C.I. No. 73915), C.I. Pigment Red 192, C.I. Pigment Red 202 (C.I. No. 73907), C.I. Pigment Red 207 (C.I. No. 73900, 73906) and C.I. Pigment Red 209 (C.I. No. 73905); quinacridonequinone pigments such as C.I. Pigment Red 206 (C.I. No. 73900/73920), C.I. Pigment Orange 48 (C.I. No. 73900/73920) and C.I. Pigment Orange 49 (C.I. No. 73900/73920); anthraquinone pigments such as C.I. Pigment Yellow 147 (C.I. No. 60645); anthanthrone pigments such as C.I. Pigment Red 168 (C.I. No. 59300); benzimidazolone pigments such as C.I. Pigment Brown 25 (C.I. No. 12510), C.I. Pigment Violet 32 (C.I. No. 12517), C.I. Pigment Yellow 180 (C.I. No. 21290), C.I. Pigment Yellow 181 (C.I. No. 11777), C.I. Pigment Orange 62 (C.I. No. 11775) and C.I. Pigment Red 185 (C.I. No. 12516); disazo condensation pigments such as C.I. Pigment Yellow 93 (C.I. No. 20710), C.I. Pigment Yellow 94 (C.I. No. 20038), C.I. Pigment Yellow 95 (C.I. No. 20034), C.I. Pigment Yellow 128 (C.I. No. 20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No. 20050), C.I. Pigment Red 144 (C.I. No. 20735), C.I. Pigment Red 166 (C.I. No. 20730), C.I. Pigment Red 220 (C.I. No. 20055), C.I. Pigment Red 221 (C.I. No. 20065), C.I. Pigment Red 242 (C.I. No. 20067), C.I. Pigment Red 248, C.I. Pigment Red 262 and C.I. Pigment Brown 23 (C.I. No. 20060); disazo pigments such as C.I. Pigment Yellow 13 (C.I. No. 21100), C.I. Pigment Yellow 83 (C.I. No. 21108) and C.I. Pigment Yellow 188 (C.I. No. 21094); azo pigments such as C.I. Pigment Red 187 (C.I. No. 12486), C.I. Pigment Red 170 (C.I. No. 12475), C.I. Pigment Yellow 74 (C.I. No. 11714), C.I. Pigment Yellow 150 (C.I. No. 48545), C.I. Pigment Red 48 (C.I. No. 15865), C.I. Pigment Red 53 (C.I. No. 15585), C.I. Pigment Orange 64 (C.I. No. 12760) and C.I. Pigment Red 247 (C.I. No. 15915); indanthrone pigments such as C.I. Pigment Blue 60 (C.I. No. 69800); phthalocyanine pigments such as C.I. Pigment Green 7 (C.I. No. 74260), C.I. Pigment Green 36 (C.I. No. 74265), C.I. Pigment Green 37 (C.I. No. 74255), C.I. Pigment Blue 16 (C.I. No. 74100), C.I. Pigment Blue 75 (C.I. No. 74160:2) and 15 (C.I. No. 74160); triarylcarbonium pigments such as C.I. Pigment Blue 56 (C.I. No. 42800) and C.I. Pigment Blue 61 (C.I. No. 42765:1); dioxazine pigments such as C.I. Pigment Violet 23 (C.I. No. 51319) and C.I. Pigment Violet 37 (C.I. No. 51345); aminoanthraquinone pigments such as C.I. Pigment Red 177 (C.I. No. 65300); diketopyrrolopyrrole pigments such as C.I. Pigment Red 254 (C.I. No. 56110), C.I. Pigment Red 255 (C.I. No. 561050), C.I. Pigment Red 264, C.I. Pigment Red 272 (C.I. No. 561150), C.I. Pigment Orange 71 and C.I. Pigment Orange 73; thioindigo pigments such as C.I. Pigment Red 88 (C.I. No. 73312); isoindoline pigments such as C.I. Pigment Yellow 139 (C.I. No. 56298) and C.I. Pigment Orange 66 (C.I. No. 48210); isoindolinone pigments such as C.I. Pigment Yellow 109 (C.I. No. 56284) and C.I. Pigment Orange 61 (C.I. No. 11295); pyranthrone pigments such as C.I. Pigment Orange 40 (C.I. No. 59700) and C.I. Pigment Red 216 (C.I. No. 59710); and isoviolanthrone pigments such as C.I. Pigment Violet 31 (C.I. No. 60010).

A combination of two or more organic pigments or organic pigment solid solutions may be used for the colorant.

In addition, any of the following may be used: particles composed of a core of e.g., silica, alumina or resin on the surface of which is fixed a dye or pigment, dyes that have been rendered into insoluble lakes, colored emulsions, and colored latexes. Resin-coated pigments may also be used. These are called microencapsulated pigments, and are commercially available from, for example, Dainippon Ink & Chemicals, Inc. and Toyo Ink Manufacturing Co., Ltd.

For a good balance of optical density and storage stability, the volume-average particle size of the pigment particles included in the liquid is preferably in a range of from 10 to 250 nm, and more preferably from 50 to 200 nm. Here, the volume-average particle size of the pigment particles may be measured by a particle size distribution analyzer such as the LB-500 manufactured by Horiba, Ltd.

A single colorant may be used alone or two or more colorants may be used in admixture. Differing colorants may be used for the respective droplets and liquids that are deposited, or the same colorant may be used.

### (Other Components)

Known additives and ingredients other than those described above may also be used in the ink and/or undercoat liquid in accordance with the intended purpose.

### Storage Stabilizer:

It is preferable to add a storage stabilizer to the ink and undercoat liquid (especially the ink) in order to inhibit undesirable polymerization during storage. It is desirable for the storage stabilizer to be used in the presence of a polymerizable or crosslinkable material. Also, it is advantageous for the storage stabilizer to be soluble in the droplet or liquid which includes it or in another ingredient present therein.

Exemplary storage stabilizers include quaternary ammonium salts, hydroxylamines, cyclic amides, nitrites, substituted ureas, heterocyclic compounds, organic acids, hydroquinone, hydroquinone monoethers, organic phosphines and copper compounds. Specific examples include benzyltrimethylammonium chloride, diethylhydroxylamine, benzothiazole, 4-amino-2,2,6,6-tetramethylpiperidine, citric acid, hydroquinone monomethyl ether, hydroquinone monobutyl ether and copper naphthenate.

It is preferable to suitably adjust the amount of storage stabilizer added based on the activity and polymerizability of the polymerization initiator or the polymerizability of the crosslinkable material, and on the type of storage stabilizer. However, for a good balance of storage stability and curability, it is advantageous to set the solids equivalent of the storage stabilizer in the liquid to from 0.005 to 1 wt %, more preferably from 0.01 to 0.5 wt %, and even more preferably from 0.01 to 0.2 wt %.

### Conductive Salts:

Conductive salts are solid compounds which enhance the electrical conductivity. In the practice of the invention, owing to the concern that deposition may occur during storage, it is preferable for substantially no conductive salt to be used. However, in cases where the solubility is good because the solubility of the conductive salt has been increased or a conductive salt having a high solubility in the liquid component is used, a suitable amount of conductive salt may be added.

Exemplary conductive salts include potassium thiocyanate, lithium nitrate, ammonium thiocyanate and dimethylamine hydrochloride.

### Solvents:

In the invention, a known solvent may be used if necessary. The solvent may be used for such purposes as to improve the polarity, viscosity and surface tension of the liquid (ink), to improve the solubility or dispersibility of the colored material, to adjust the electrical conductivity, and to adjust the printability.

For quick-drying properties and to record high-quality images having uniform line widths, it is preferable that the solvent be a water-insoluble liquid which contains no aqueous medium. Hence, a composition which uses a high-boiling organic solvent is desirable.

It is preferable for the high-boiling organic solvent to have an excellent compatibility with the components of the liquid, especially the monomer.

Specific examples of preferred solvents include tripropylene glycol monomethyl ether, dipropylene glycol monomethyl ether, propylene glycol monomethyl ether, ethylene glycol monobutyl ether, diethylene glycol monobutyl ether, triethylene glycol monobutyl ether, ethylene glycol monobenzyl ether and diethylene glycol monobenzyl ether.

Known solvents also include low-boiling organic solvents with boiling points of up to 100° C. However, owing to concerns over the adverse effects of solvents on curability and taking into account also environmental contamination by low-boiling organic solvents, it is desirable not to use such solvents. If a low-boiling organic solvent is used, the solvent is preferably a highly safe solvent. A “highly safe solvent” refers herein to a solvent having a high control level (the “control level” is an indicator used in the Working Environment Evaluation Standards issued by the Japanese Ministry of Health, Labor and Welfare) of preferably at least 100 ppm, and more preferably at least 200 ppm. Exemplary solvents of this type are alcohols, ketones, esters, ethers and hydrocarbons. Specific examples include methanol, 2-butanol, acetone, methyl ethyl ketone, ethyl acetate and tetrahydrofuran.

The solvent may be used singly or as combinations of two or more. When water and/or a low-boiling organic solvent are used, the amount in which both are used is preferably from 0 to 20 wt %, and more preferably from 0 to 10 wt %, based on each liquid (ink or undercoat liquid). The substantial absence of such solvents is especially preferred. The substantial absence of water in the ink and undercoat liquid used in the invention improves stability over time with respect to clouding of the liquid caused by, for example, a loss of homogeneity and dye deposition over time, and is also able to increase dryability when used on an impermeable or a slowly permeable recording medium. Here, “substantial absence” signifies that the presence of such solvent as an inadvertent impurity is allowable.

### Other Additives:

Use can also be made of known additives such as polymers, surface tension adjusters, ultraviolet light absorbers, antioxidants, discoloration inhibitors and pH adjusters.

Known compounds may be suitably selected and used as the surface tension adjusters, ultraviolet light absorbers, antioxidants, discoloration inhibitors and pH adjusters. For example, use may be made of the additives mentioned in JP 2001-181549 A.

In addition to the above, a pair of compounds which, when mixed, react to form an agglomerate or thicken may be separately included in the ink and undercoat liquid according to the invention. This pair of compounds has the characteristic of either rapidly forming an agglomerate or rapidly thickening the liquid, thereby more effectively inhibiting the coalescence of mutually neighboring droplets.

Examples of reactions between the pair of compounds include acid-base reactions, hydrogen bonding reactions between a carboxylic acid and an amide group-bearing compound, crosslinking reactions such as between boronic acid and a diol, and reactions involving electrostatic interactions between cations and anions.

The undercoat liquid preferably has a different composition than the above-described ink. Moreover, the undercoat liquid preferably includes at least one polymerizable or crosslinkable material, and preferably includes also, if necessary, a polymerization initiator, oleophilic solvent, colorant and other ingredients.

The polymerization initiator is preferably one which is able to initiate a polymerization reaction or crosslinking reaction by exposure to active energy rays. The use of such an initiator enables an undercoat liquid that has been applied to the recording medium to be cured by exposure to active energy rays.

Moreover, as noted above, it is preferable for the undercoat liquid to also include a radical-polymerizable composition. In this invention, “radical-polymerizable composition” refers to a composition which contains at least one radical-polymerizable material and at least one radical polymerization initiator. Such a composition enables the undercoat liquid curing reaction to be carried out at a high sensitivity in a short period of time.

Although embodiments of the ink-jet recording method and ink-jet recording device of the present invention have been described for illustrative purposes, those skilled in the art will appreciate that various modifications and improvements are possible without departing from the scope and spirit of the invention as disclosed in the accompanying claims.

What is claimed is:

1. An ink-jet recording method for recording an image by ejecting onto a recording medium an ink which cures upon exposure to active energy rays, comprising:
an applying step of an undercoat liquid for applying the undercoat liquid to said recording medium so as to form thereon an undercoat layer of the undercoat liquid having a surface state;
an improving step of the surface state for improving the surface state of the applied undercoat layer;
a semi-curing step of the undercoat liquid for semi-curing the undercoat liquid of said undercoat layer having the improved surface state; and
an image-forming step for forming the image by ejecting the ink onto a semi-cured surface of the undercoat liquid of said undercoat layer.

2. The ink-jet recording method of claim 1, wherein said improving step is carried out by blowing air over a coated surface of the undercoat liquid of said applied undercoat layer.

3. The ink-jet recording method of claim 2, wherein said air blown over the coated surface of said applied undercoat layer has a temperature of at least 25° C. but not more than 60° C.

4. The ink-jet recording method of claim 1, wherein said image-forming step is carried out by forming a multicolor image comprised of inks of at least two colors, said image-forming step comprising:
two or more single-color image-forming sub-steps, each single-color image-forming sub-step for forming a single-color image in one of said at least two colors by successively ejecting one of said inks of said at least two colors onto the recording medium; and
one or more ink semi-curing sub-steps, each ink semi-curing sub-step for semi-curing said one of said inks which has been ejected onto the recording medium and is present uppermost thereon between said two single-color image-forming sub-steps for two respective colors.

5. The ink-jet recording method of claim 1, wherein said undercoat liquid is a clear, white or achromatic liquid which includes a radical-polymerizable composition and is curable on exposure to said active energy rays.

6. The ink-jet recording method of claim 1, further comprising, following said image-forming step, a step of completely curing said undercoat liquid of said undercoat layer and said ink of said image.

7. An ink-jet recording device comprising:
applying means of an undercoat liquid for applying the undercoat liquid onto a recording medium so as to form thereon an undercoat layer of the undercoat liquid having a surface state;
improving means of the surface state for improving the surface state of the applied undercoat layer, said improving means being disposed downstream from said applying means;
semi-curing means of the undercoat liquid for semi-curing the applied undercoat liquid of said undercoat layer by exposure to active energy rays, said semi-curing means being disposed downstream from said improving means;
image-forming means for forming an image by ejecting an ink which is curable on exposure to the active energy rays onto a semi-cured surface of the undercoat liquid of said undercoat layer, said image-forming means being disposed downstream from said semi-curing means; and
complete curing means for completely curing by exposure to the active energy rays said undercoat liquid of said undercoat layer and said ink of said image, said complete curing means being disposed downstream from said image-forming means.

8. The ink-jet recording device of claim 7, wherein said improving means comprises means for blowing air over a coated surface of the undercoat liquid of said applied undercoat layer.

9. The ink-jet recording device of claim 8, wherein said air blown over the coated surface of said applied undercoat layer has a temperature of at least 25° C. but not more than 60° C.

10. The ink-jet recording device of claim 7, wherein said image-forming means has at least two ink-jet heads, each ink-jet head ejecting one of inks containing mutually differing colorants, respectively, said ink-jet recording device further comprising:
at least one ink semi-curing means for semi-curing one of the inks used to form the image with one of said at least two ink-jet heads which is disposed on an upstream side thereof in a direction of travel of said recording medium, said one of said at least one ink semi-curing means being disposed between two ink-jet heads.

11. The ink-jet recording device of claim 7, wherein said undercoat liquid is a clear, white or achromatic liquid which includes a radical-polymerizable composition and is curable on exposure to said active energy rays.
